(19) United States
(12) Patent Application Publication
(10) Pub. No.: US 2010/0122220 A1
(43) Pub. Date: May 13, 2010

(54) Method of and apparatus for dynamically generating a user presentation based on database stored rules

(75) Inventors: John Patrick Ainsworth, San Diego, CA (US); Young Sang Cho, El Cajon, CA (US); Geoffrey James Hueter, El Cajon, CA (US); Steven Charles Quandt, Encinitas, CA (US); Helen Ann Schultes, San Diego, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Carl Zeiss MicroImaging GmbH

(21) Appl. No.: 12/460,978

(22) Filed: Jul. 27, 2009

Related U.S. Application Data
(63) Continuation of application No. 12/402,384, filed on Mar. 11, 2009.
Application No. 12/402,384 is a continuation of application No. 09/240,048, filed on Jan. 29, 1999, now abandoned.

(51) Int. Cl. G06F 3/048; G06N 5/02

(52) U.S. Cl. 715/866; 706/47

(57) ABSTRACT

A method of dynamically generating a user presentation includes selecting and retrieving at least one of a plurality of rules stored in one or more databases in response to a request from an application program, executing the rule to retrieve data from the one or more databases, and generating presentation data based on the data. The presentation data may be for use in the user presentation of the application program.

### RELATED APPLICATIONS

This application is a continuation of application Ser. No. 12/402384 filed Mar. 11, 2009, which is a continuation of application Ser. No. 09/240048 filed Jan. 29, 1999, all of which are hereby fully incorporated herein by reference.

### BACKGROUND OF THE INVENTION

1. Field of the Invention

The present invention relates generally to user presentations, and more particularly to user presentations in telemedicine applications.

2. Description of the Related Art

Worldwide, people living in rural and remote areas often struggle to access timely, quality medical care. Residents of these areas often have substandard access to health care primarily because physicians tend to be located in areas of concentrated population. Due to innovations in computing and telecommunications technology, however, many facets of the medical practice are now realizable for the patient and health care provider who are geographically separated (whether it be across town, across state, or across the world).

“Telemedicine” often involves the sharing and/or transfer of medical information in a data communications network for purposes related to patient health. Sometimes referred to as “telehealth” or “distance health care,” telemedicine may involve the bringing of health care services to a location where the individual client is most accessible or comfortable, while keeping costs down by making efficient use of resources. For example, electronic access to patient data and videoconferencing “visits” between a health care provider and the patient can, in many instances, replace traditional face-to-face visits.

The information shared and/or transferred may include patient records, high resolution images, stored or live audio, and stored or live video, all of which may be accessible through remote servers and databases. The telemedicine network may utilize a variety of telecommunications technologies, including ordinary telephone lines or Plain Old Telephone Systems (POTS), Integrated Services Digital Network (ISDN), fractional to full T-1's, Asynchronous Transfer Mode (ATM), the Internet, intranets, and satellites. Overall, telemedicine provides increased ubiquity, convenience, and efficiency in health care services.

Today, telemedicine is making a difference in the lives of many people across the world. In remote rural areas, where a patient and the closest health professional can be hundreds of miles apart, telemedicine can mean access to health care where little had been available before. In those cases where fast medical response time and specialty care are needed, telemedicine availability is critical and can mean the difference between life and death. Telemedicine also brings a wider range of services (e.g., radiology, mental health services, and dermatology) to underserved communities and individuals in both urban and rural areas. It also helps attract and retain health professionals in rural areas by providing ongoing training and collaboration with other health professionals.

A health professional or other user may interact with a telemedicine network using a telemedicine application program on a computer. Telemedicine software generates a user interface presentation for the user to execute his/her series of particular tasks or telemedicine “workflow.” The user interface presentation typically includes that which is visually displayed on a screen of the computer's monitor; the execution is handled using appropriate input/output (I/O) devices at the computer. For example, the software may provide an easy-to-use graphical user interface (GUI) or multimedia interface. GUIs are well known, and typically include visually displayed objects for “point-and-click” functionality using a mouse, touchscreen, or voice activation. A multimedia interface is an extension to the GUI that includes audio, video, image, and even input for the other senses including touch, smell, and taste.

The user of the telemedicine software may be one of many people who serve specialized or limited functions, and who have specialized or limited needs and access rights to and within the network. For example, telemedicine is being utilized by a growing number of medical specialists, including dermatologists, oncologists, radiologists, cardiologists, psychiatrists, and home health care specialists. Not only health care providers, but payers, employers, patients, pharmacies, laboratories, and other organizations may interact with the system to share data. Even within each group, there are often users who serve different functions and have special needs and access rights (e.g., a group may include a health care specialist, a nurse, and support staff). Each of these users expects a user interface presentation that accommodates their particular needs and workflow. In many instances emergency health situations are presented, where the appropriate presentation of data and functionality is critical and determine the outcome.

A developer of telemedicine software typically has to struggle to accommodate each user with software that provides such unique presentations. Providing several versions of software is costly in terms of software development, maintenance, and administration. Source code needs to be edited and/or added, re-compiled, and delivered for each version of software. If this undesirable development strategy is chosen, the added costs involved are likely to be passed on to purchasers of the software.

As an alternative, the developer may provide only a single or a limited number of software versions having a single or limited number of presentations. Since many different kinds of users will interact with it, the presentation will likely be too “functionally congested” for any one user to intuitively understand his/her particular workflow. Put another way, such a presentation will not be ergonomically appropriate for each user. In addition, the savings associated with this presentation inflexibility will be at the expense of using customers who prefer to have customized presentations.

Accordingly, there is a need for a method and apparatus in telemedicine and other fields that overcomes these and other deficiencies of the prior art.

### SUMMARY OF THE INVENTION

In one embodiment described, a method of dynamically generating a user presentation comprises selecting and retrieving at least one of a plurality of rules stored in one or more databases in response to a request from an application program; executing the rule to retrieve data from the one or more databases; and generating presentation data based on the data, where the presentation data is for use in the user presentation of the application program.

### BRIEF DESCRIPTION OF THE DRAWINGS

FIG. 1 is an illustration of a computer network 100, which may be a telemedicine network;

FIG. 2 is a block diagram of a client 200 of computer network 100;

FIG. 3 is a block diagram of defined layers of computer network 100;

FIGS. 4 and 5 are block diagrams describing a more particular architecture;

FIGS. 6A and 6B are flowcharts describing a method of client interaction within network 100;

FIGS. 7A and 7B are flowcharts describing a method of server interaction within network 100;

FIG. 8 is a flowchart describing a method of dynamically generating a user presentation based on database stored rules;

FIG. 9 is a flowchart describing a method of building a page of “navigation” framework type;

FIG. 10 is an example illustration of a screen of the navigation framework type;

FIG. 11 is a flowchart describing a method of building a page of “list” framework type;

FIG. 12 is an example illustration of a screen of the list type;

FIG. 13 is a flowchart describing a method of building a page of “data I/O” framework type;

FIG. 14 is an example illustration of a screen of the data I/O framework type;

FIG. 15 is a flowchart describing a method of entering, into the system, a page of the “user-defined” type;

FIG. 16 is an example illustration of a screen showing the “user-defined” type;

FIG. 17 is an example illustration of an “Audio Note” screen of the data I/O framework type;

FIG. 18 is an example illustration of a “Text Note” screen of the data I/O framework type;

FIG. 19 is an example illustration of an “Image Import” screen of the data I/O framework type;

FIG. 20 is an example illustration of a screen of the data I/O framework type, where the screen incorporates several system and user defined components;

FIG. 21 is an example illustration of the data I/O framework type, where the screen incorporates system and user-defined components;

FIG. 22 is a flowchart describing the function LoadActionObjects;

FIG. 23 is a flowchart describing the function LoadActionObjectStoredProcedure;

FIG. 24 is a flowchart describing the function GetListHeaders;

FIG. 25 is a flowchart describing the function GetListObjects;

FIG. 26 is a flowchart describing the function LoadColumnStoredProcedure;

FIG. 27 is a flowchart describing the function LoadLabels;

FIGS. 28A and 28B are flowcharts describing the function GetDataFrames;

FIG. 29 is a flowchart describing the function LoadDataItemProcedure;

FIG. 30 is a flowchart describing the function GetSelectorList;

FIG. 31 is a flowchart describing the function LoadDataItem;

FIG. 32 is a flowchart describing the function AddValue;

FIG. 33 is a flowchart describing the function SaveNewDataItem;

FIG. 34 is a flowchart describing the function UpdateDataItem;

FIG. 35 is a state diagram describing an alert notification subsystem;

FIG. 36 is a block diagram describing a general design of the alert notification subsystem;

FIG. 37 is an example illustration of a presentation including an Alert User Interface; and

FIG. 38 is a block diagram describing interfaces and processes related to an Alert Processor.

### DETAILED DESCRIPTION OF THE PREFERRED EMBODIMENTS

Portions of the disclosure of this patent document contain material that is subject to copyright protection. The copyright owner has no objection to the facsimile reproduction by anyone of the patent disclosure, as it appears in the Patent and Trademark Office files or records, but otherwise reserves all copyright rights whatsoever.

A method of dynamically generating a user presentation based on database stored rules serves a great need in computer networks, and especially in telemedicine networks. In one aspect, the method comprises selecting and retrieving at least one of a plurality of rules stored in one or more databases in response to a request from an application program; executing the rule to retrieve data from the one or more databases; and generating presentation data based on the data, where the presentation data is for use in the user presentation of the application program. The rules may be executed using control information (such as user information, group information, geographic location information, and node information) as input. The data retrieved from execution of the rules may be data such as user data or presentation control data.

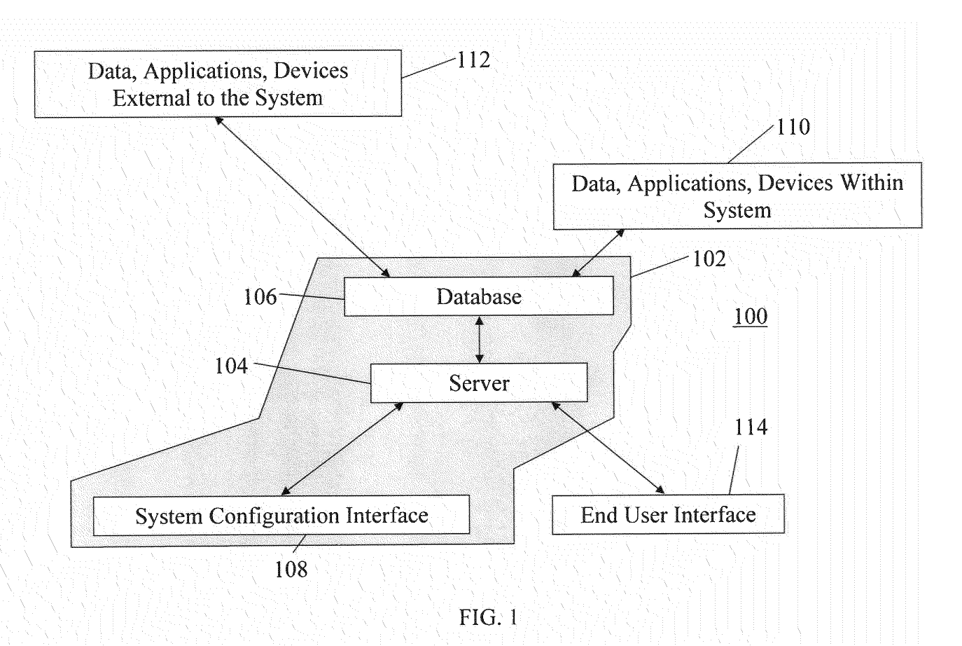

FIG. 1 is a block diagram illustrating a computer network or system 100, which may be a telemedicine network or system. Typically, system 100 includes one or more servers 104, a database 106 (such as one or more databases and database servers, and/or database warehouses) for storing data, a system configuration interface 108 which provides system configuration through a system administrator, an end user interface 114 for a user to access the system. Internal elements 110 and external elements 112 as described in FIG. 1 may also be included. Server 104 executes server software to manage several aspects of system 100. End user interface 114 (or client, or client workstation) may be a desktop computer or other device providing (input/output) I/O capabilities. As suggested by an outline 102 of FIG. 1, a user at end user interface 114 has a degree of independence from server 104, database 106, and system configuration interface 108.

As a telemedicine network, system 100 includes most required conventional aspects of such, providing those same or similar desired features outlined above in the Background Of The Invention. For example, the information shared and/or transferred at end user interface 114 may include full multimedia patient records, high resolution images, stored or live audio, and stored or live video, all of which may be accessible through remote servers and databases such as server 104 and database 106. System 100 may utilize a variety of telecommunications technologies, including ordinary telephone lines or Plain Old Telephone Systems (POTS), Integrated Services Digital Network (ISDN), fractional to full T-1's, Asynchronous Transfer Mode (ATM), the Internet, intranets, and satellites.

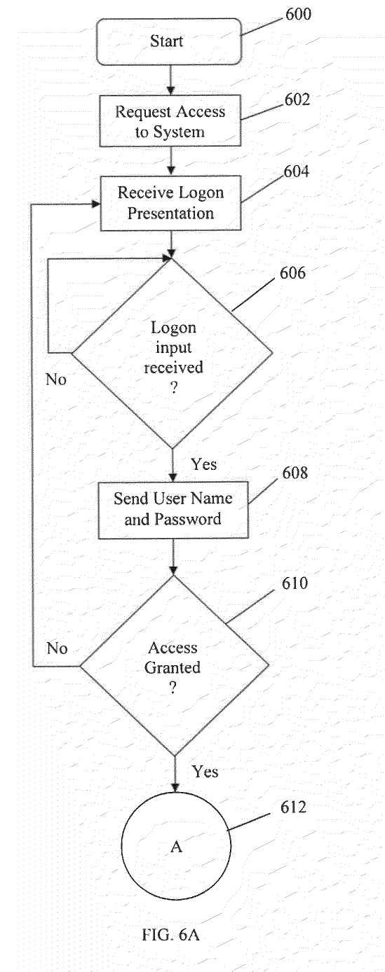

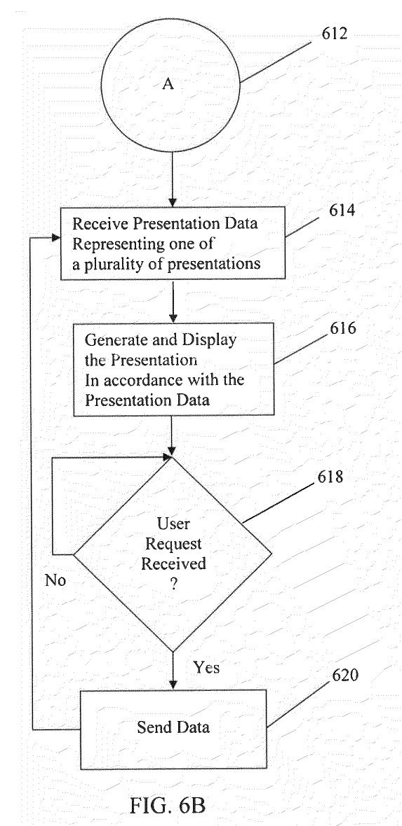

Referring now to FIGS. 6A and 6B, flowcharts that describe a method of client interaction within the network are shown. Starting at a start block 600, client requests access to the system (step 602). In response to the access request, client receives a logon screen at the visual display (step 604). The logon screen awaits logon information, such as a user name and a password or biometric information, from the user (step 606). The user enters the logon information, where client then sends the information to the server (step 608). If access is granted from the server (step 610), the flowchart continues at a connector 612 (connector “A”) to FIG. 6B.

At FIG. 6B, client receives presentation data representing one of a plurality of presentations (step 614). Client generates and displays, on the visual display, the presentation according to the presentation data (step 616). Client then waits for a request from the user (step 618). If a request is received, then data in connection with the request is sent to server (step 620). In response to the request, client receives from the server presentation data representing another one of a plurality of presentations (step 614). The method repeats as shown, until the user logs off the system or the connection is terminated based on a configured timeout.

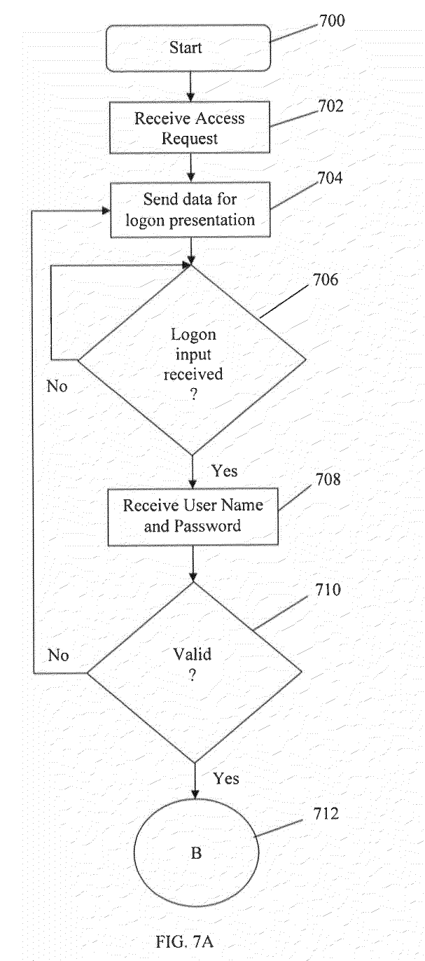

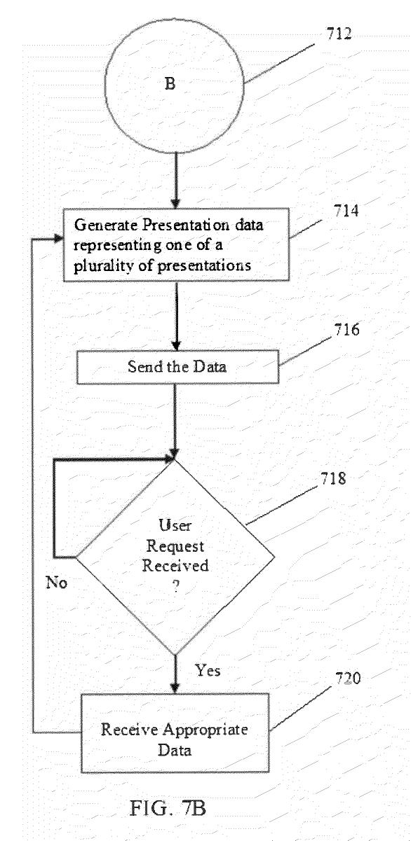

FIGS. 7A and 7B are flowcharts describing a method of server interaction within the network. Starting at a start block 700, the server receives a request from the client to access the system (step 702). In response to the access request, the server sends data for the logon screen to the client (step 704). The server awaits logon information from the user (step 706). The server receives the logon information from the client (step 708). If determined to be valid (step 708), the server grants the client access to the system where the flowchart continues at a connector 712 (connector “B”) to FIG. 7B. Valid logon information establishes a session that is used to service client requests for presentation of accessible data and supported features and functions.

At FIG. 7B, the server generates presentation data representing one of a plurality of presentations (step 714). Server sends the presentation data to the client (step 716). Server then waits for a request from the user (step 718). When the request is received, appropriate data in connection with the request is received by the server (step 720). In response to the request, the server generates presentation data representing another one of a plurality of presentations (step 714) and sends the data to the client (step 716). The method repeats as shown, until the user logs off the system or the connection to the system is terminated based on the configured timeout.

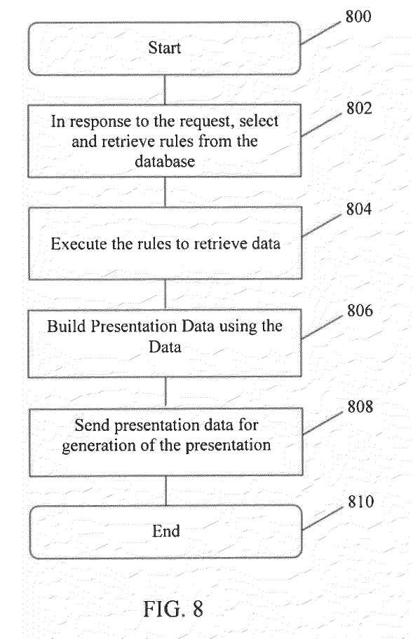

FIG. 8 is a flowchart describing a method of dynamically generating a user presentation, which may be incorporated into steps 714 and 716 of FIG. 7B. Starting at a start block 800, the server selects and retrieves user presentation rules from one or more databases in response to a request by the client (step 802). The server executes these user presentation rules to retrieve data from the database(s) (step 804). The server builds presentation data using this data (step 806). The presentation data is formatted and sent by the server for the generation of the user presentation at the client (step 808). The flowchart ends at a block 810.

The user presentation rules may be referred to as presentation instructions. Many user presentation rules may be stored in the database (tens, hundreds, thousands, etc.). When accessed by the server software, a subset of the user presentation rules may be selected (referring back to step 802) based on one or more of several different types of information (selection criteria), such as user identification, user group identification, user request or requested function or page, node identification, geographic location identification, hardware/software capabilities or availabilities of the accessing node, data being presented, patient identification, patient diagnosis, patient treatment, medical test results, medical history of the patient, patient's relatives, or ethnic group, etc. Once obtained, the user presentation rules may be executed with one or more of several different types of input information (execution criteria) into the rule (referring back to step 804), such as user identification, user group identification, user request or requested function or page, node identification, geographic location identification, hardware/software capabilities or availabilities of the accessing node, time, date, data being presented, patient identification, patient diagnosis, patient treatment, medical test results, medical history of the patient, patient's relatives, or ethnic group, etc. The different types of information may be stored in the database or sent with client request.

Some examples of user rules are provided below in plain English for understanding and clarity. These examples are by no means exhaustive:
Provide a navigation button having a link to “Cancer Task Force” page only if USER GROUP=“Cancer Task Force”;
Provide a patient scheduling function button given if 9:00 am <TIME< 5:00 pm and USER=“Assistant”;
Get patient data only for USER=“Dr_Ainsworth”;
Provide image functionality interface only if H/S CAPABILITIES OF THE ACCESSING NODE=“image_compatible”;
Present all containers or base data in this container to all requesting users who are members of group G1 but not USERS=(U1, U2, U3, . . . ) and not in group G2;
If ENTRY=“new pediatric patient”, create all basic pediatric forms for the clinic (F1[new patient form], F2[growth chart], . . . , FN), with the appropriate data of the patient added to the forms, and calculate dates for inoculations for state, federal, or health plan mandated/supported inoculations based on the patient's age, prior inoculations, and the insured's health plan; and
Provide selection of a mammogram lab test only if the patient is of GENDER=“female”, “X years” <AGE< “Y years”, MASTECTOMY=“no”, and the patient's medical plan (per the insured) allows an exam without explicit approval per the time since the patient's last mammogram; AND create an instance of the reporting form F1 to the medical plan with the appropriate patient data and forward it to INSUR_CO per INSUR_CO_COMMUNICATIONS_METHOD and the lab request F2 to LAB supported under the insured's insurance plan per LAB_COMMUNICATIONS_METHOD, with process P scheduled to reschedule the patient for a follow-up examination at location L with the clinician requesting the lab result C1 or their designated alternates C3→Cn based on priority at the point where the results from the lab are R1→Rn, but not R6, and in the case of R6, alert clinician C2. that the patient is to be informed via email if EMAIL=“enabled” and/or phone if PHONE_NOTIFICATION=“on” and/or by mail if MAIL NOTIFICATION=“on”.

The user presentation rules are-stored in the database, and thus may be modified, added, or deleted—without affecting the compiled server source code that evaluates them. New rules or modifications to existing rules can be made by a network administrator, or a user if given appropriate access rights and/or knowledge. When a new customer or group is given access to the system, or if an existing customer has new needs, new user presentation rules can be added or modified per customer request without having to change the compiled server source code. The server source code architecture is configured so that it can interpret the rules to produce presentation of any I/O objects supported by the system, initiate any process or interface supported by the system or other accessible systems, or initiate an I/O action by a user related to a presentation.

The user presentation preferably comprises data and graphical user interface (GUI) components or a multimedia interface. A GUI is indeed a “graphical” interface—in contrast to purely “textual” interface—to a computer program application. GUIs came into existence following the first interactive user interfaces to computers which were not graphical, but merely keyboard driven using text commands. The command interface of the disk operating system (DOS) operating system is an example of the typical user-computer interface before GUIs arrived. GUI terminology include one or more metaphors for objects familiar in real life, such as a desktop, a view through a window, or the physical layout of a building. Elements of a GUI are known and described as windows or browser, pull-down menus, buttons, scroll bars, iconic images, wizards, images, a mouse, etc. With the increasing use of multimedia, sound, voice, motion video, and more are becoming part of the GUI or multimedia interface.

User data is stored in the databases for many different users to access, but with restrictions. For example, patient data for many doctors is stored in a telemedicine network, but typically every doctor has rights to view only patient data associated with his/her own patients. However, some or all of the patient data may need to be shared between users depending on the need. As another example, an assistant to a doctor may have rights to see limited portions of patient data (e.g.; that data required for patient scheduling) while the doctor has rights to see all of the data associated with his/her patients. With the dynamic GUI presentation, for example, users having rights to all or some of the same data can view the same data with different presentations.

Thus, users in a computer network can be provided with potentially limitless flexibility in user presentations to accommodate their particular needs and workflow. Appropriate restrictions to functionality and data are enhanced and more flexible. For everyday convenience, and in cases where emergency situations are presented, the ergonomically appropriate presentation of data and functionality will be of great assistance. A developer of software no longer has to struggle to accommodate each user by changing the compiled source code, minimizing costs for themselves and purchasers.

As described, the methods herein are employed using software for use on one or more servers. The software may be embodied on one or more storage mediums (e.g., computer disks), or made available for server use by other suitable means (e.g., electronic transfer).

Provided below are embodiments describing, in more detail, approaches used with respect to building dynamic presentations. The detailed embodiments do not serve to limit the scope of the invention, but only to enable one skilled in the art how to practice the invention in better detail and to disclose the best mode thereof.

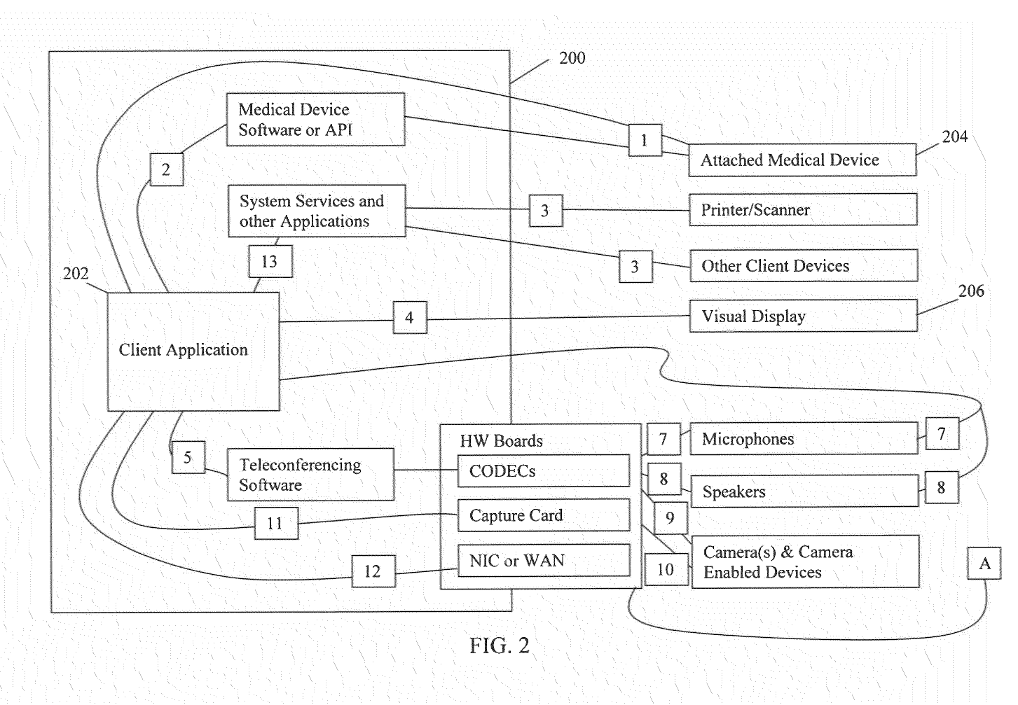

FIG. 2 is a block diagram of a client 200. Client 200 may be a simple workstation (desktop computer), for example, or one embellished with telemedicine devices and applications as shown. Client 200 runs a client application 202, which embodies or houses a Web browser to enable the user to access the server via Transmission Control Protocol/Internet Protocol (TCP/IP) (Internet, intranet, Local Area Network (LAN), Wide Area Network (WAN)). At (1), medical devices attach to client 200 and either directly interface with client application 202 or medical device software. At (2), client application 202 interfaces with the medical device software to access and present medical device data. At (3), printers, scanners, and other devices attached to client 200 use system services to support processing requested by client application 202. At (4), client application 202 presents the user with a GUI on a visual display monitor 206 for initiating access to all of client's 200 services (applications, data, printers, scanners, etc.). User initiated input is processed by client application 202 which determines the availability of the service, initiates the services, and presents the user with the resulting data or presentation from the service. At (5), client application 202 interfaces with teleconferencing software to manage teleconferencing connections using the teleconferencing standards appropriate for client 200 configuration (e.g., either H.320 or H.323).

At (6), the teleconferencing software manages a coder/decoder (CODEC) interface. At (7), microphone(s) are shared between the CODEC and the client application 202 to initiate audio capture and audio/video capture capabilities; these may also be routed by the application to other media (for example, a Virtual Tape Storage media) capable of storing audio, audio/video, or multimedia data. At (8), speakers are shared between the CODEC and client application 202 to initiate audio replay. At (9), camera(s) and camera enabled devices are attached to the CODEC. Client application 202 controls the display and functions of the CODEC and teleconferencing software's interface to the camera. This includes live video display, self and remote views, camera source selection, and remote and automated camera control. At (10), the camera(s) can also be attached to a capture card capable of capturing still images or video from these camera sources. Cameras supporting TWAIN or other application interfaces can be connected to the client using available supported ports (serial, parallel, Universal Serial Bus (USB), Firewire, etc.) and interfaced to the application for the input of still image or multimedia acquisition. At (11), client application 202 controls the interface to the capture card in response to user requests for image or video capture. At (12), client application 202 controls the interface to the LAN or WAN connections on client 200 to access a web server. These can be via a network interface card (NIC), modems, or CODECs. At (13), client application 202 processes all user input and coordinates system services and other application presentation and services for users.

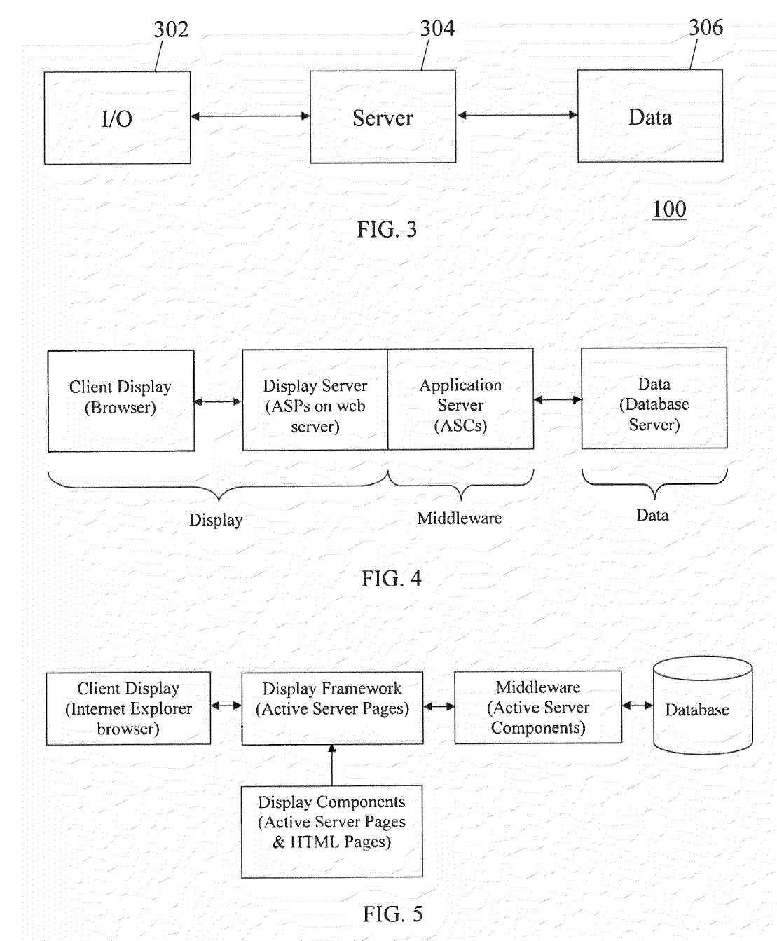

Referring now to FIG. 3, an overview of system 100 of FIG. 1 is provided. System 100 is based on an N-tiered client-server architecture. Three layers that comprise the system are an I/O layer 302, a server layer 304, and a data layer 306. I/O layer 302 renders and presents the information to the user, and receives and processes input from the user. Server layer 304 processes the user requests and stores/retrieves the information for the user. Data layer 306 stores the data (user and system data) and makes the data available for storage/retrieval by server layer 304. The reason this architecture is N-tiered is that the server layer and the data layer can be distributed across numerous logical and physical devices.

FIGS. 4 and 5 describe the particular architecture utilized in the present embodiment As shown, the client display is hosted on a client machine running the display element of a web browser, such as Microsoft (MS) Internet Explorer (IE) web browser (version 4.01) provided by Microsoft Corporation of Redmond, Wash. The display screens for the web browser are generated and served from a web server, such as an MS Internet Information Server (IIS) (version 4.0), using Active Server Pages (ASP) technology. The user and system data used by the ASP to build and present the various presentations of the system are supplied by Active Server Components (ASC) running on an application server, such as MS Transaction Server (MTS) (version 2.0). The ASCs store and retrieve the data from a database server, such as an MS SQL Server (version 6.5), which provides the mechanism for data storage. All of this Microsoft technology is well known and understood by those skilled in the art.

The Internet is a network of networks which facilitates the transfer of data among numerous users who are connected to the network. The World Wide Web (the “Web”) is the name of a high level user interface which has been created on the Internet to make transfers of data easier and more logical. The Web provides users with a distributed menu system. Menu pages or screens are displayed to users through which the user can easily request information from another computer, or host. One feature of the Web is the ability to nonlinearly link or jump from one set of information to another through display elements called hypertext links. When a screen displays something in the characteristic of a hypertext link, the user has the ability to click on the hypertext element and immediately be transferred to the data or information, identified by the hypertext, whether the data is at the same host as the displayed information or at some other host location somewhere else in the world. Typically, the user has the ability to thereafter click back to the original screen display, or follow a sequence of links to sought-after information which can then be transmitted, or downloaded, from that host. A Uniform Resource Locator (URL) is an address for a resource on the Internet. Web addresses with the prefix “http://” denote Web screens with hypertext linking capability which conform to published RFC standards.

HyperText Markup Language (HTML) pages describe what a Web browser will display on the screen at a remote terminal. This includes buttons text, images, animated real time loops of images, sounds, and so forth. Web pages contain HTML tags of data which describe how the page is to be interpreted by a Web browser at a remote terminal. For reference only, HTML pages may be directly encoded in software by following that published in a number of reference texts such as HTML and CGI Unleashed, by John December and Mark Ginsburg, published by Sams.net Publishing, Indianapolis, Ind.; simple HTML pages may be written using desktop publishing and word processing software, then encoded in HTML form using software known as the Internet Assistant, which may be downloaded through Microsoft's homepage at www.microsoft.com; public domain software known as “Web-maker” may be downloaded from the Internet and used to make Web pages.

Referring back generally to FIGS. 4 and 5, typical usage of the system is described. The system is initiated. The web browser engine that constitutes the display requests the logon screen from the web server. The web server renders the logon screen and sends it to the browser, and the browser displays the logon screen. The user types in a username and password. This information is sent back to the web server which in turn sends the username and the password to the application server that validates the username and the password against the entries in the database.

If the username and password are valid, then the appropriate home screen (i.e., the first screen presented to that user) is built, typically based on (at least in part) the logged on user's group membership, rules for the user, and the user's interface language preference. Most presentations are built using generic display framework code on the web server, where one of several different generic frameworks is called to build the requested screen. In the embodiment described, three generic frameworks are designed: the navigation framework, data list framework, and the data I/O framework.

The appropriate generic framework calls the necessary application server functions to retrieve system data (information used to render the page) and user data (user input information) stored in database(s). The generic framework uses the returned system data as “blueprint” information to render the appropriate page using pre-defined display components as building blocks. The pre-defined display components are stored in the web server as files and utilized as needed. The client code (HTML) needed to render the requested screen is constructed on the web server and sent to the client display. The client display “paints” the screen and awaits user interaction and input. In accordance with the user inputs or requests, the requested screens are built using the display framework, the display components, and the database data.

A particular feature that makes the system unique relates to the fact that the “blueprint information” required to build the various screens and associated functions is stored in the database and is modifiable without changes to the compiled server program. The compiled code for the system acts merely as a general framework to allow the user to configure and extend the system to match how the user will use the system (e.g., appropriate for his/her “workflow”).

The architectural design of the system is configurable to accommodate different technology or platform selections. For example, the display does not have to be implemented using web server/web browser technology, but can use any I/O device. Any suitable database management system (DBMS) may also be used, such as any American National Standards Institute (ANSI) compliant SQL relational DBMS.

### Terminology Used in the Detailed Embodiment

User. A “user” is a person who accesses the system. Typically, the user is authorized to access the system and has a logon name and valid password. A user is defined in the system with a unique logon name on the server that they initially connect to. Users can span multiple servers or resources. In the case where the user access to information and functions spans multiple servers or other resources, they are identified to those resources unambiguously.

Group. A “group” is a collection of users associated together to share access to the same or similar presentation, functionality, and/or data. A group is identified by a unique group name. Users may belong to any number of groups. Grouping of users is provided to allow the system to be configured to meet the needs of a client organization as it relates to making users “like” one another for purposes of data sharing or access to available resources.

Location. A “location” is the client node or the physical workstation from which the user interacts with the system. The location is identified with a unique symbolic location name as well as a unique location description. Along with the location identification, the capabilities of the location to support applications and the various multimedia capabilities of that location are stored in the database(s) so that the user can be presented with only those options supported at the location.

Session. A “session” is the work performed by a particular user over some period of time: A session is characterized by a given user on a specific location of the system, from logon until logoff. The session is identified with a unique id that is programmatically generated when the session is initiated.

Presentation. In general, a “presentation” is that information conveyed by or used at an I/O device to provide all or some part of a user interface. The information may include output information and control information. In this embodiment, the presentation comprises a GUI presentation provided at a visual display monitor or a “screen” (see below). However, other “presentations” may be used to accomplish I/O processing and provided at other types of I/O devices (e.g., a touch screen display, voice-activated device, etc.).

Screen. “Screens” are the visual display presentations provided to the user, on a visual display (e.g., computer display monitor). Screens are dynamic in that they may display different functional objects as well as different data. The criteria for determining functionality and data access is typically based on (but not limited to) user, group, and location specification.

Page. A “page” is the canvas upon which the various display elements are rendered. The pages are dynamically rendered based on configuration data in the database. The result of rendering the page is a screen or screen region (subset of the entire display area) which is displayed to the user. A page is typically virtual and as such its definition in the database requires only is a unique symbolic page name. A real active server page may optionally be correlated with the symbolic name.

Display Component. “Display components” are used by the various frameworks to build pages. They typically provide a GUI for some functionality, such as audio record/playback, text note, image capture, etc. A display component may embody one or more Base Objects.

Action Object. An “action object” is a display element that effects some sort of action when selected by the user. Action objects are used to invoke new functionality, which may-result in navigation to a new screen. For example, the user may select “Patient List” to navigate to a presentation of all patients to which they have access. An action object may also represent requests for client or server processing appropriate to the current function being performed by the user. For example, the user may select “Print” to obtain a hard copy print out of the patient list, and yet not have a resulting change in the screen displayed after initiation of the action. An action object is rendered per its definition that includes a specification not only for the location on the page, but also the label and/or image to be drawn. Based on the available information, action objects may be rendered as hyperlink text, hyperlink images with or without text, buttons, or other visual or even audible controls (e.g., voice-activated action objects).

Label. A “label” is that which is displayed (e.g., a text string) in association with some object, and can be interpreted based on a designated language of the user. Labels are associated with pages for generic text display, visual display, audio presentation or other multimedia presentation; lists for column headings; and action objects for associating a label with an action. Labels may be stored in the database in multiple languages. The “languages” supported may include customized client versions that resemble dialects. The database configuration for a user includes their display language of choice. Labels are retrieved from the database and rendered on the display in the language/preference of the user. Defining a label in the system involves providing a unique symbolic name for the label and the actual text string/multimedia object associated with the label in each of the languages supported. In this way, the client can also effectively produce an interface that is unique without any change to the application code or executables.

Language. “Language” refers to a set of presentation items that can be configured by a user or set of users. This can relate to text: human language, dialects, specific terminology for an organization, etc. It can also include multimedia presentation data that can be configured by a user or set of users to support a unique presentation.

Container Type. A “container type” is a term used to represent data in the system that has a container hierarchy type structure. Lists are an example of containers. The list itself contains some number of columns. Containers are one of the system data building blocks. A container can contain other containers or base data. Containers also have attributes (name, display, image, audio presentation, creation date, etc.), all of which can be used in a presentation of the container, or used to sort or order groups of containers within a presentation.

Base Object. The multimedia data elements (Base Data) that are presented as a unit by the system, and for which there is no further decomposition, are created by Base Objects. Base Objects come in two “flavors”: those that are system defined and are data building blocks thereof (text producing, image producing, audio producing, audio/video producing, Health Level 7 (HL7) message producing, notification producing, or other interface protocol producing objects for example), and those that are client or system defined based on a combination of system Base Objects (scanner producing, progress note producing, Digital Imaging and Communications in Medicine (DICOM) producing, client application interface producing, for example). Base Objects specify the attributes (name, display image, audio presentation, creation date, creation user, X/Y presentation size and units, etc.) that each Base Data instance will have.

Base Data. “Base Data” are instances of data based on user I/O with a Base Object. They are the multimedia data elements that are presented as a unit by the system and for which there is no further decomposition. Base Data also have attributes (name, display image, audio presentation, creation date, user creating the Base Data instance, etc.), all of which can be used in a presentation of the Base Data or used to sort or order groups of Base Data within a presentation.

List. A “list” is a display element that provides a tabular presentation of data. A list is a specialized container type. Columns of a list are defined in the database, whereas rows in a list (actual data elements) are determined by an action rule of the selected action object. A list itself is defined with a unique symbolic container type name. Then, the following information is provided for each column displayed in the list: label (used for column heading); column rule (an SQL query resulting in the desired attribute for the data element); load order (defines order which should be used to retrieve to information for the database); display order (defines the order for rendering the information on the tabular presentation); and display format (optional parameter to specify special formatting to be performed on the data value).

Sequence Presentation. A “sequence presentation” is a presentation that allows multiple pages to be displayed simultaneously, in a consecutive fashion, in a data I/O framework (e.g., using frames for a browser). Each sequence is specified in the database with a unique symbolic name. Each page of a sequence presentation is defined with information including display order, submit order, data type, HTML page name, and HTML anchor name.

Access Rule. “Access rules” are instructions associated with action objects to control availability of functionality. At runtime, the access rules are fired and, based on the outcome, an action object will be enabled or disabled for a particular instance of a page's rendering. In this embodiment, an access rule is an SQL query which is stored in the database. While the access rule may evaluate based on the user, user group(s), prior presentations (routes) to the current presentation, and client node configuration information stored in the database, it is not prohibited from utilizing any criteria in its evaluation. An access rule is defined using a unique symbolic rule name and the rule expression (e.g., SQL query). The rule must be encoded to return at least one value to enable the functionality.

Action Rule. “Action rules” are instructions associated with action objects to control access of data (e.g., patient records). At runtime, the action rule is fired to return identification for the data elements that are to be displayed. In this embodiment, an action rule is an SQL query which is stored in the database. An action rule is defined using a unique symbolic rule name and the rule expression (e.g., SQL query). The rule is encoded to return identification of all data elements to be displayed.

More on Action Objects. Availability of action objects is controlled by access rules. Selection of an action object navigating to another page that displays data, utilizes the action rule associated with the action object to limit data access. An action object is defined using the following information: a unique symbolic action object name; an access rule; an action rule (optional unless the action object navigates to another screen displaying data); a label (optional if an image is to be displayed representing selection); an image (optional if a label is to be displayed representing selection); a URL (parameter identifying action to be performed given user selects the action object); URL parameters (optional parameter identifying any additional information required by the action object handler if the action object is selected); a list type (optional unless the action object is a column of a list presentation); an action type (optional unless for action objects associated with a list presentation); a launch (optional parameter used to direct the launch of a new browser for display of resultant screen); and a target (optional parameter to identify the screen region to be updated with new display). Once defined, the action objects are associated with pages. In the embodiment described, this association includes: a unique symbolic page name; a unique symbolic action object name; a screen location identifier; and a display order (to control the placement of action objects on the page in the same location).

### Implementation of the Detailed Embodiment

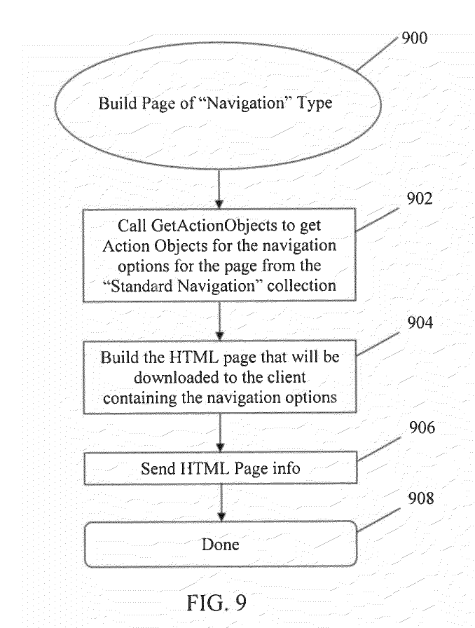

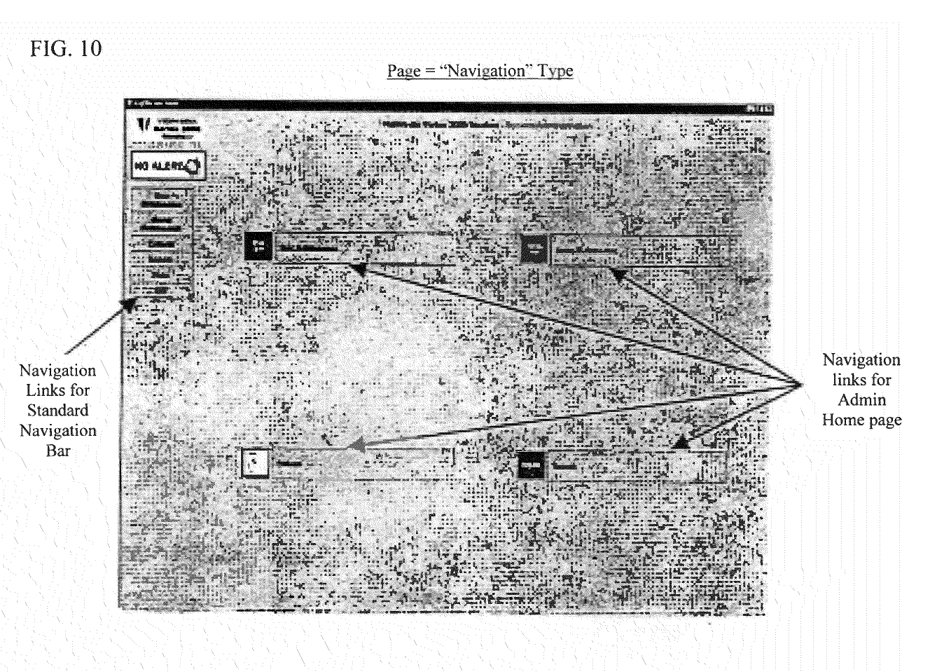

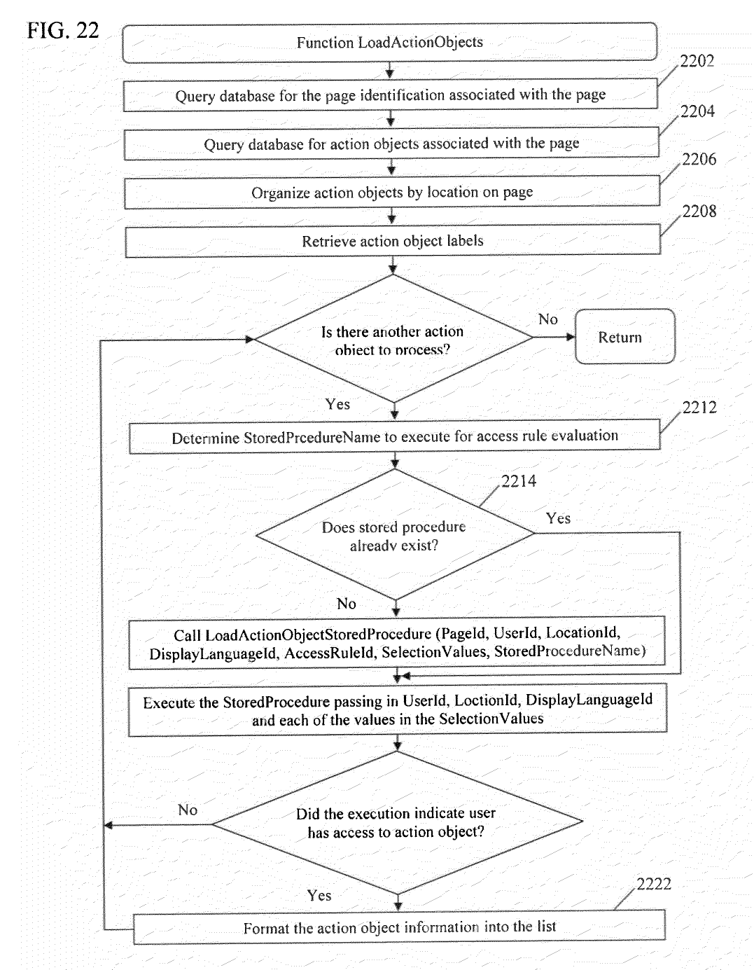

FIGS. 9, 11, and 13 are flowcharts describing the methods of building/assembling different types of presentation pages. FIGS. 10, 12, and 14 are example illustrations of those presentation types and correspond to FIGS. 9, 11, and 13, respectively. With respect to the flowcharts of FIGS. 9, 11, and 13, and the associated flowcharts of FIGS. 22-33, APPENDIX A describing the associated database tables should be referenced. In this embodiment, one of the different general framework types is selected and executed based on the request (e.g., requested screen) from the client. In addition, the methods described in relation to FIGS. 9, 11, and 13 are executed with software, using ASP technology.

FIG. 9 is a flowchart describing a method of building or assembling a presentation page of the “navigation” type. An illustration of the navigation type screen is shown in FIG. 10. The navigation display framework builds the menu selections that allow the user to navigate to the various screens of the system. The action object in the context of the navigation page provides a mechanism to allow the user to move to a different screen within the system.

Beginning at a start block 900 in FIG. 9, the web server calls a LoadActionObjects function in the application server to get Action Objects from a “Standard Navigation” collection for the navigation options (step 902). LoadActionObjects is described later in relation to FIG. 22. Next, the web server builds an HTML page using the Action Objects (step 904). The web server sends this HTML page information to the client for presentation (step 906). At the client, the browser renders the standard navigation screen using the information, and the browser waits for a user selection or request. The flowchart ends at a block 908. Once a navigational action object has been clicked or selected by the user, the browser will navigate to the requested screen.

The following information is used from the “Standard Navigation” Action Objects: Navigation label; Navigation page name (URL); Navigation parameters (URL Parameters); Navigation page target (display region); Navigation icon/thumbnail image; and Navigation Action Object ID number.

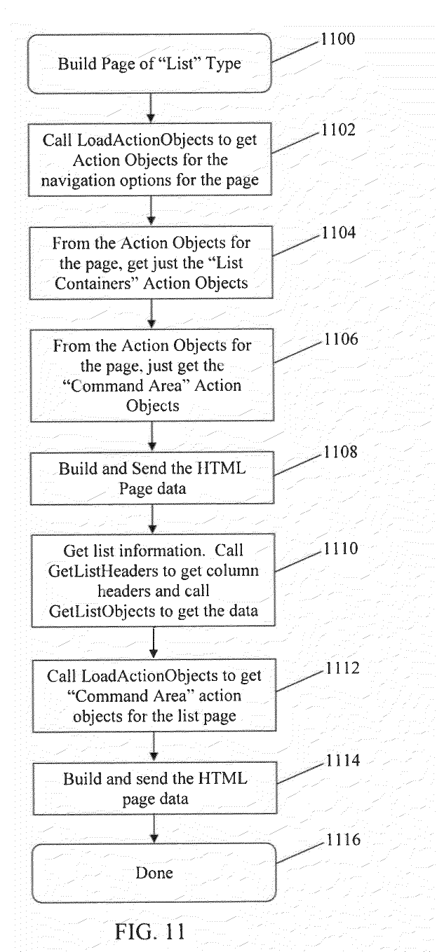

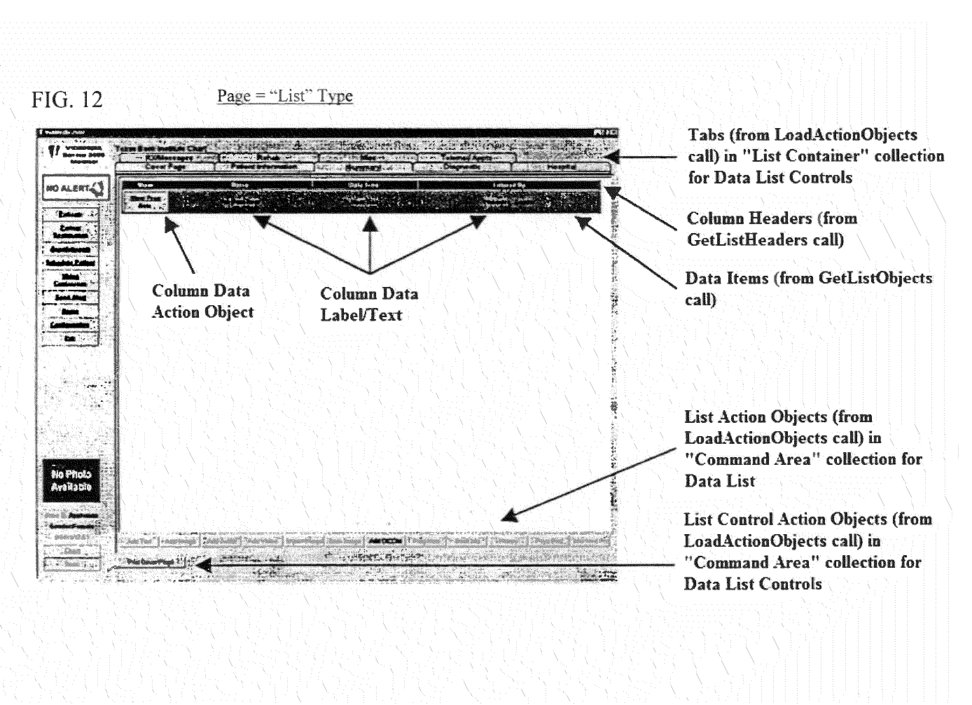

FIG. 11 is a flowchart describing a method of building or assembling a presentation page of the “list” type. An illustration of the list type screen is shown in FIG. 12, which includes the main components thereof. As shown, the data list display framework is used to display a list of items to the user. Beginning at a start block 1100 in FIG. 11, the web server calls the LoadActionObjects function (FIG. 22) in the application server to get Action Objects for the navigation options for the page (step 1102). Next, the web server selects the “List Containers” Action Objects (step 1104) and the “Command Area” Action Objects (step 1106) from the returned Action Objects. The web server builds and sends the HTML page data to the client for presentation (step 1108). At the client, the browser renders the outer portions of the tabbed list page (tabs, command buttons). The preceding steps are associated with Data List Controls—drawing the control portion of the list page (e.g., tabs).

The following information is used from the “List Containers” Action Objects (at step 1104): Number of tabs; Tab label font name, size & weight; Tab label; Tab status (enabled or disabled); Tab navigation page name (URL); Tab navigation parameters (URL Parameters); and Tab Action Object ID number. The following information is used from the “Command Area” Action Objects (at step 1112): Command button label; Command button Action Object ID number; Command button navigation page or action subroutine call; Command button navigation page parameter or subroutine parameter; and Command button navigation target (page region).

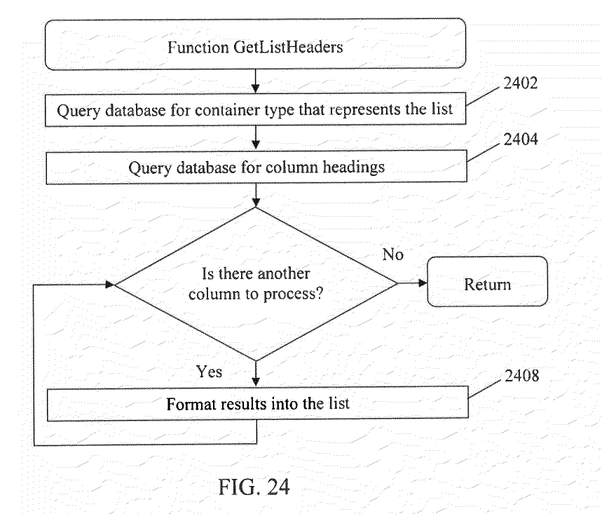

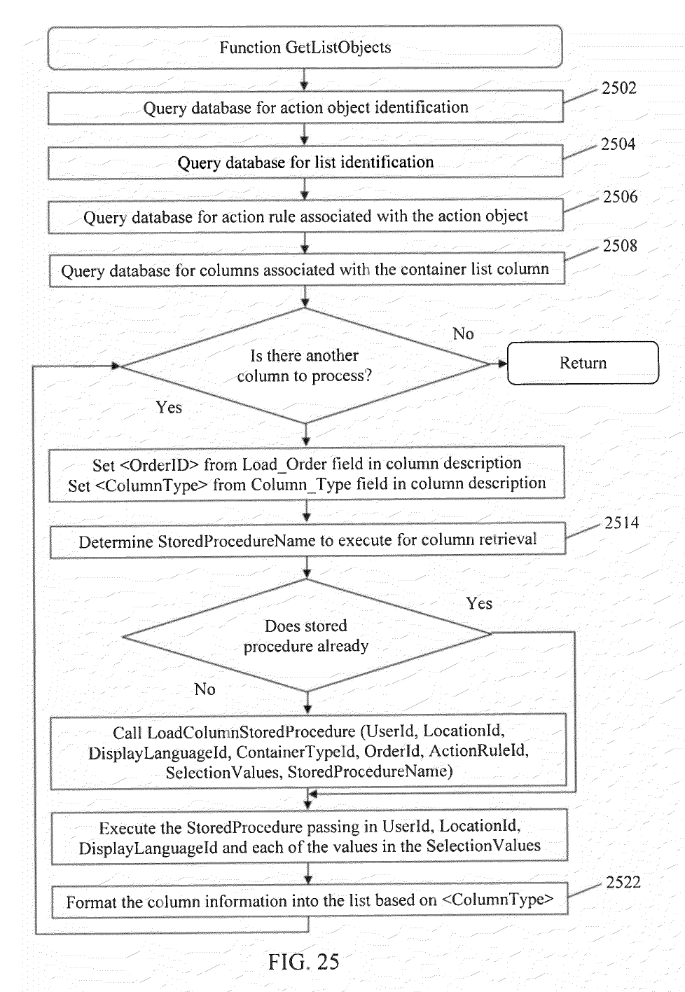

Next, the web server calls a GetListHeaders function in the application server to get column headers, and calls a GetListObjects function in the application server to get appropriate data (step 1110). GetListHeaders is described later in relation to FIG. 24, and GetListObjects is described later in to relation to FIG. 25. The web server then calls the LoadActionObjects function (FIG. 22) in the application server to get “Command Area” Action Objects for the list page (step 1112). The web server builds and sends the HTML page data to the client for presentation (step 1114). At the client, the browser renders the data table with the header and data list information using the data, and the browser waits for a user selection or request. The preceding steps (steps 1110-1114) are associated with the Data List itself—building the actual list table and actions for the list. The flowchart ends at a block 1116.

The sequence of all the steps in FIG. 11 are executed quickly so that the user sees one new presentation screen after the client browser renders all of the HTML information. Once a tab has been clicked or selected by the user, then the “List Data” section is rendered with the requested page. If the Action Object is selected from the data list, then the browser will navigate to the requested screen.

The following information is returned from GetListHeaders for the data table header: Column header label; and Column header display order. The following information is returned from GetListObjects for each of the data table elements (cells): Column data display order; and Column data, which includes: icon/thumbnail; label/text; Action Object (contains similar information as “Command Area” button or “Standard Navigation” link); and selection checkbox.

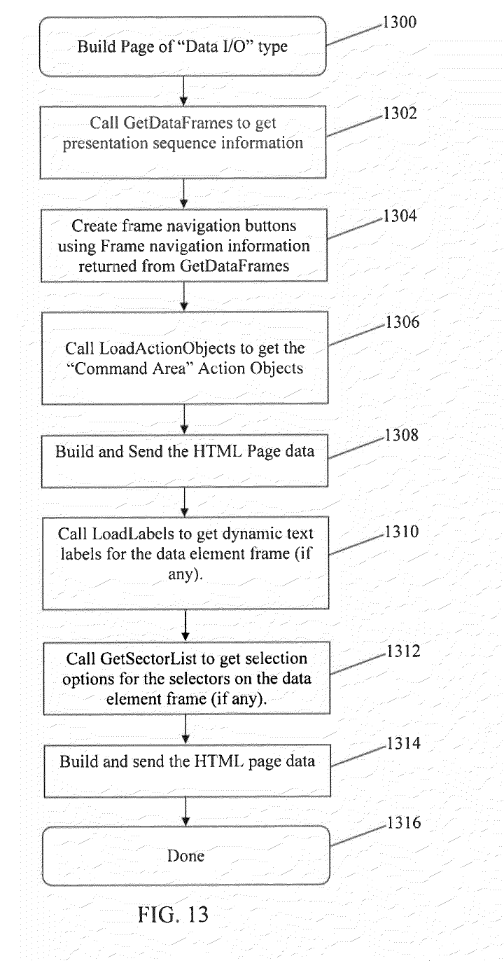

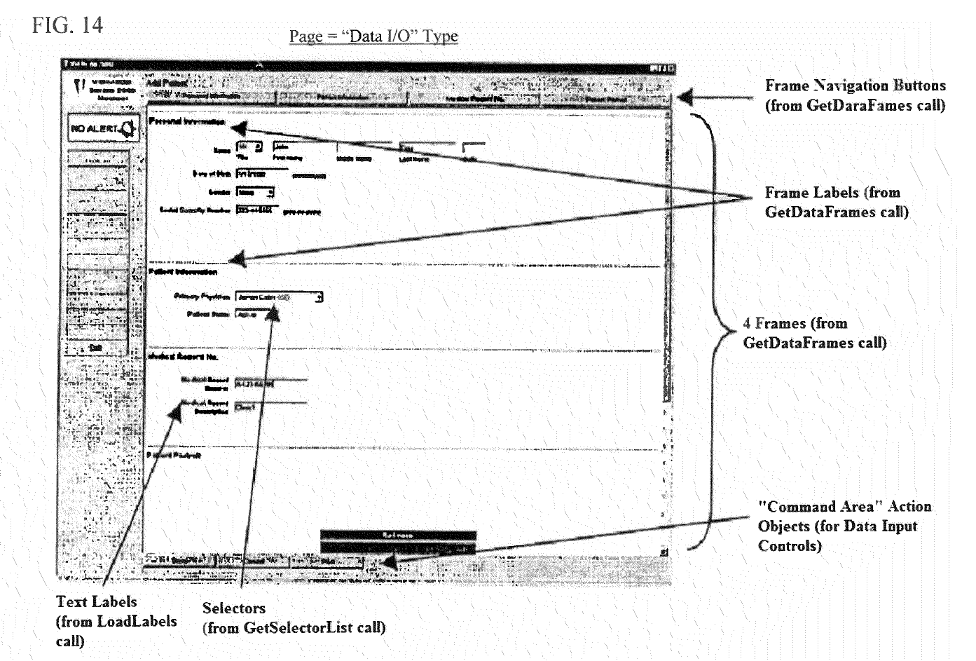

FIG. 13 is a flowchart describing a method of building or assembling a presentation screen of the “data I/O” type. An illustration of the data I/O type page is shown in FIG. 14. The data I/O framework is used to build the screens used for data input and presentation. The data I/O framework assembles various display components to produce a page that presents a data item.

These display components may be system provided components, or they may be user-created HTML files (described in more detail below). As shown in FIG. 14, the Personal Information, Patient Information, Medical Record Number and Image Capture display components are used to assemble the Patient Registration page. To generate new data pages, the user needs to only generate the display component (in HTML or ASP) and configure the database to define the new data pages.

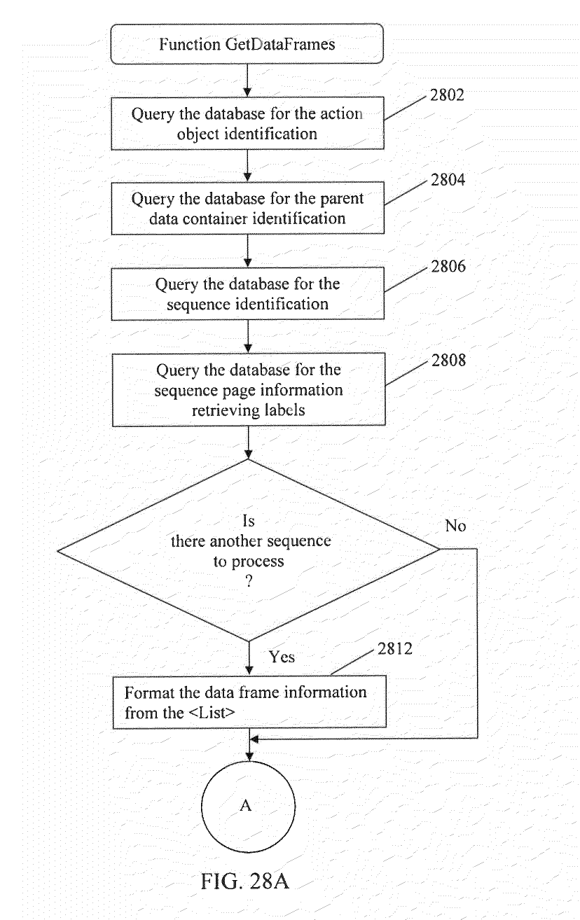

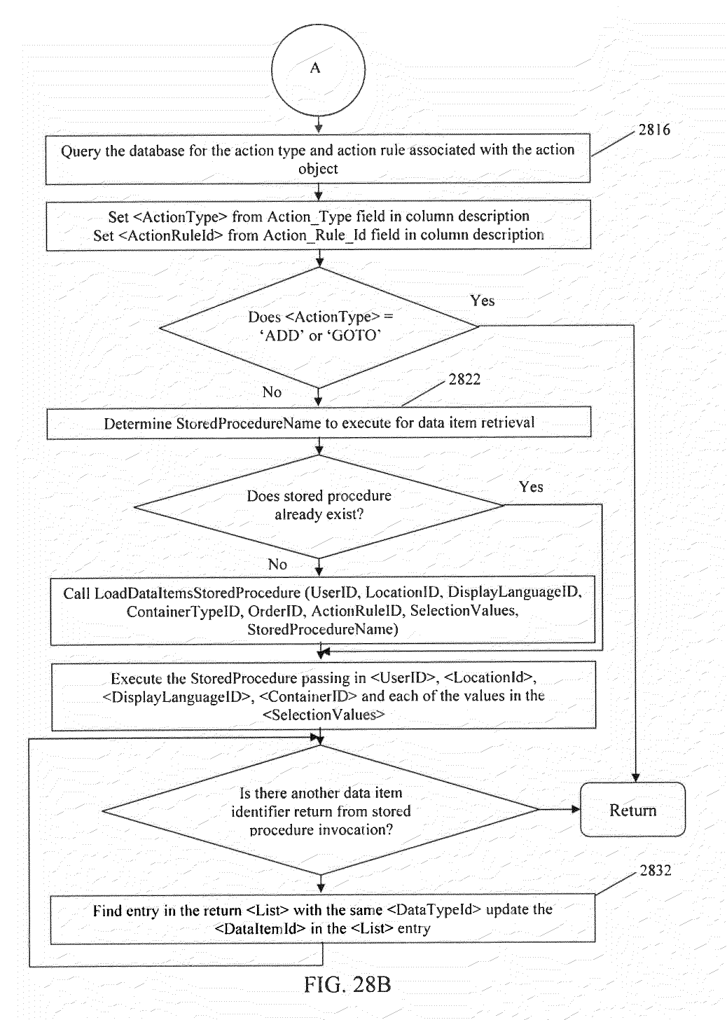

Beginning at a start block 1300 in FIG. 13, the server calls a GetDataFrames function in the application server to get sequence presentation information for the page to be rendered (step 1102). GetDataFrames is described later in relation to FIGS. 28A and 28B. Next, the web server creates frame navigation buttons using Frame navigation information returned from GetDataFrames (step 1304). Then, the web server calls the LoadActionObjects function (FIG. 22) in the application server to get the “Command Area” Action Objects (step 1306). The web server builds and sends the HTML page data to the client for presentation (step 1308). The client browser renders the data input controls (outer navigation, display, and command sections).

The following information is returned for each of the frames in a data item: Display order sequence; Submit (save) order sequence; Page label and name; Page section navigation (anchor); Component to load name (URL); Save component name (URL); Cancel component name (URL); Component display size; Electronic signature needed flag; ASC name for load/save; Data item ID (for saved data); and Data type ID. The following information is used from the “Command Area” Action Objects: Command button label; Command button Action Object ID number; Command button to navigate to different screen or to call a subroutine; Parameter for navigating to a different screen or parameters to call a subroutine; and Information for where to draw the new screen or page.

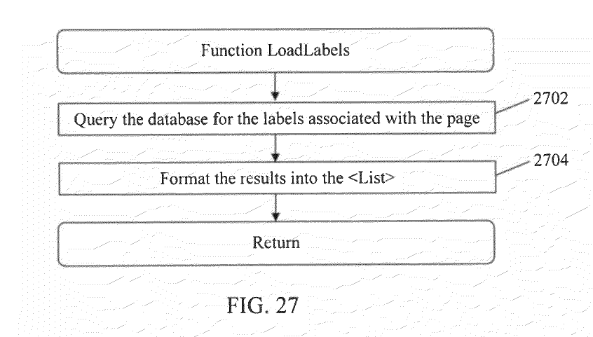

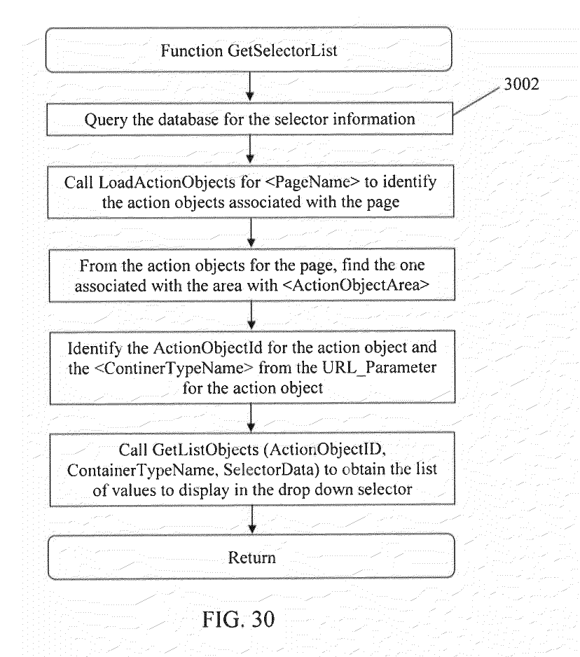

Next, the web server calls a LoadLabels function in the application server to get dynamic text labels (if any) for the data element components (step 1310). LoadLabels is described later in relation to FIG. 27. The web server then calls a GetSelectorList function in the application server to get selection options for the selectors (if any) on the data element components (step 1312). GetSelectorList is described later in relation to FIG. 30. The web server builds and sends the HTML page data to the client for presentation (step 1314). The sequence of steps in FIG. 13 are executed quickly so that the user sees one new presentation screen after the client browser renders all of the HTML information. The flowchart ends at a block 1316.

At the client, a user enters/updates data into the data element components of the screen and selects one of the “Command Area” buttons for the server to act accordingly. The browser responds to user buttons selections by: Client-side actions through scripting, such as printing the current page to paper; Navigates to a “save” page to save or update the user input data using ASCs (e.g., by calling AddValue to save the value and calling SaveNewDataItem for new data and UpdateDataItem for updates to existing data in the VMGenericData ASC); and Navigates to a “cancel” page and returns the user to the previous screen.

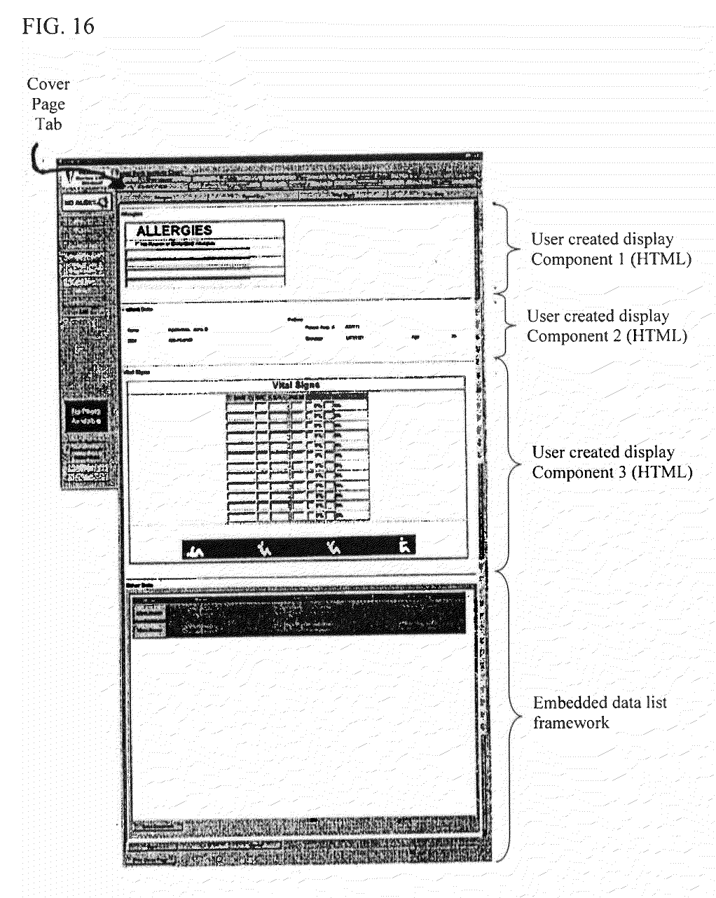

In addition to pre-defined system components, customized “user-defined” components may be utilized in the system as well. Typically, a user-defined component attempts to duplicate actual paper forms used in the user's office. As described herein, certain core display components are “pre-built” and may be used in sequence presentation definitions. These display components include the personal information component, the patient information component, the medical record number component, the data item description component, the image/portrait capture component, the scan image component, the import image file component, the audio capture component, the text input component, the video capture component, and others. To create new data I/O pages, display components may be defined in the sequence presentation definition along with user-defined display components (e.g., HTML files). No changes to the compiled, core program are necessary. An example illustration of a page including user-defined components is shown in FIG. 16. This screen contains three HTML files that are user created using an HTML generation tool (e.g., MS FrontPage '98).

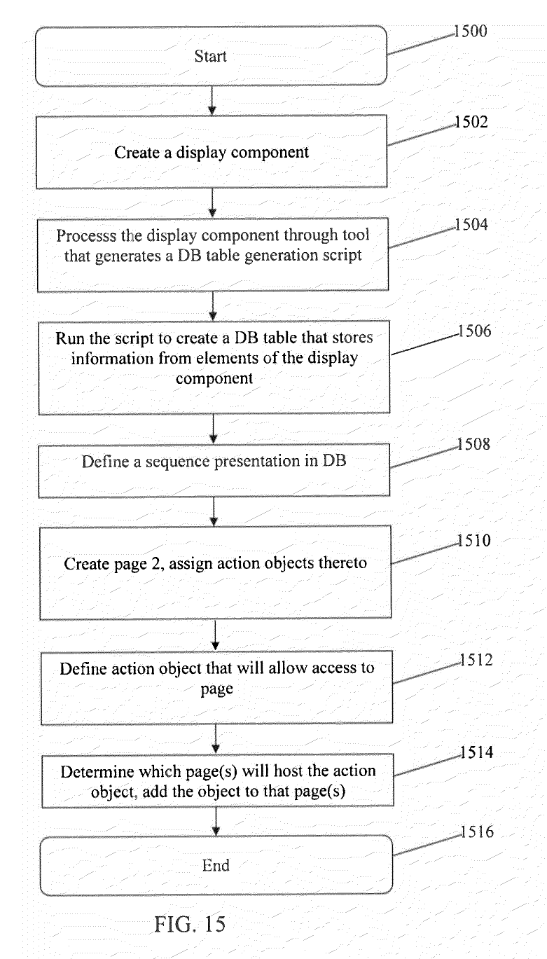

FIG. 15 is a flowchart describing a method of entering a “user-defined” component into the system for utilization in a page. Typically, this procedure would be executed by a system administrative user in a manual fashion. Starting at a start block 1500 of FIG. 15, the user creates a display component (e.g., an HTML file using an HTML generation tool) (step 1502). This component is stored in the web server as a file along with the predefined components. As shown in FIG. 16, three new display components (Allergies, Patient Data, and Vital Signs components) were created.

The newly created HTML file is processed through a software tool that generates a database table generation script (step 1504). The tool is written to scan the HTML file to look for data elements and to generate a script which, when executed, will appropriately allocate storage space in the database based on those data elements. The script is then executed to create a new database table which stores the information from input elements of the HTML file (step 1506). For example, in the “Vital Signs” section in FIG. 16, the fields corresponding to “Date”, “Wt.” (weight), “B.P.” (blood pressure), “Pulse”, and “Ht” (height) would be newly created fields of a new “Vital Signs” database table.

Next, the database is modified to define a sequence presentation (step 1508). The sequence presentation for FIG. 16 uses three user-created HTML files and an existing data list page as a component (4 display components total). The information for a sequence presentation includes: (1) what HTML/ASP components to display, (2) in what order to display the HTML/ASP components, (3) the section header text, (4) the data type specification for saving the data to appropriate database tables created using the tool, (5) the mechanism through which the data is loaded and saved, and (6) the amount of screen to dedicate to displaying the component. A generic mechanism for loading and saving the data is provided as part of the system.

The database is modified to create a sequence presentation that defines the new data I/O page and assign Action Objects to that page (e.g., Save button, Cancel button, Edit button, etc.) (step 1510). For the example above, a “Cover Page” was defined and the Save, Edit, and Cancel buttons assigned to that page. Next, the database is modified to define an Action Object that will allow access to the newly created data I/O page (step 1512). The “Cover Page” action object was created for this example. Finally, the page(s) that will host the Action Object are configured to allow access to the newly created data I/O page, and the Action Object is added to that page (step 1514). As shown in FIG. 16, the “Cover Page” action object was assigned to the “Cover Page” tab of the Patient Chart.

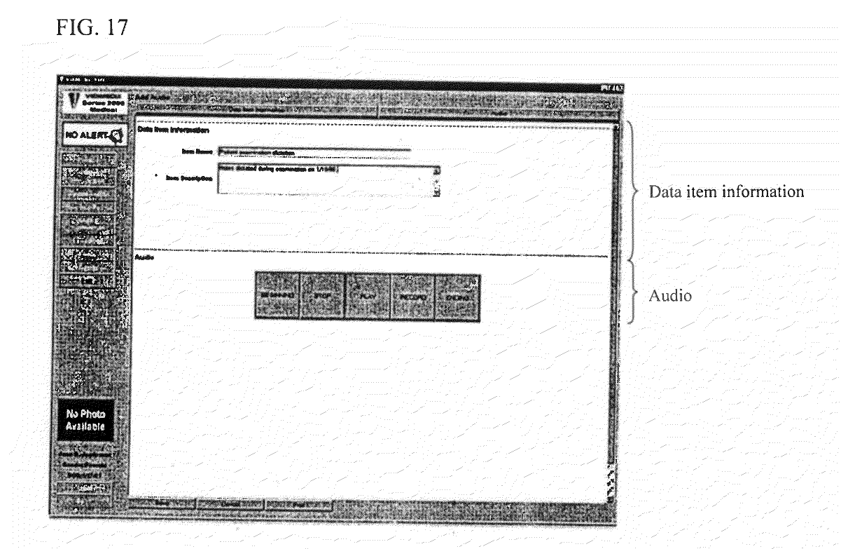

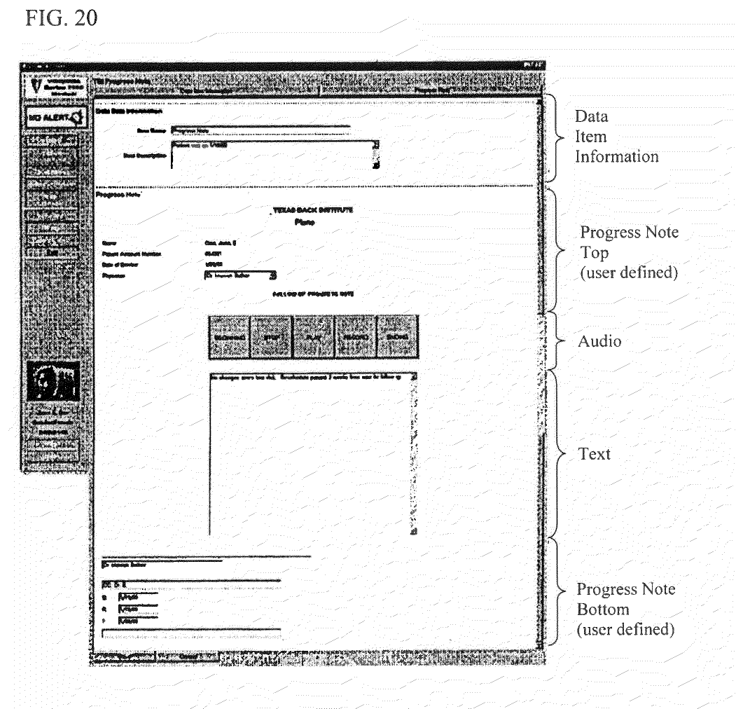

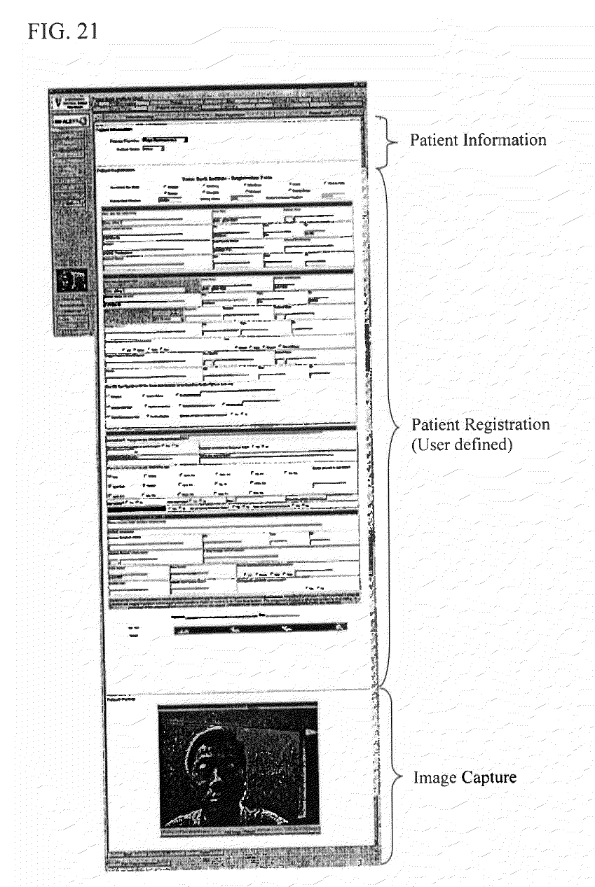

FIGS. 17-21 are example illustrations of screens dynamically generated using the methods described herein. Note that the screens of FIGS. 20 and 21, as well as the screen in FIG. 16, are shown in extended fashions for illustration clarity only and allow the use of well-known scroll bars for full viewing.

FIG. 17 is an example illustration of an “Audio Note” screen of the data I/O framework type, which has been dynamically generated using the described methods herein. A user may enter text information in the fields under Data Item Information, and record and listen to audio using the audio component area. The general framework is used to host two data I/O components. The Data Item Description and Audio components were created in ASP. The general framework code retains no specific knowledge about the two components, except what was loaded in during program execution time from the database.

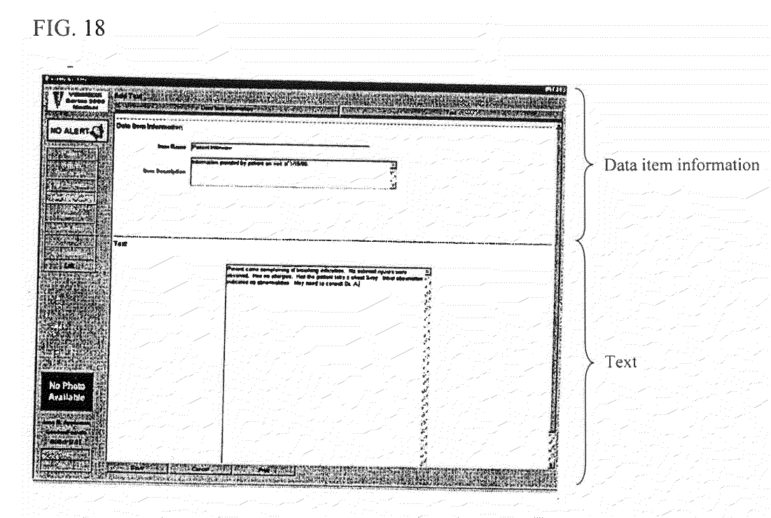

FIG. 18 is an example illustration of a “Text Note” screen of the data I/O framework type; which has been dynamically generated using the methods described herein. A user may enter text data in the fields shown and save it to the database.

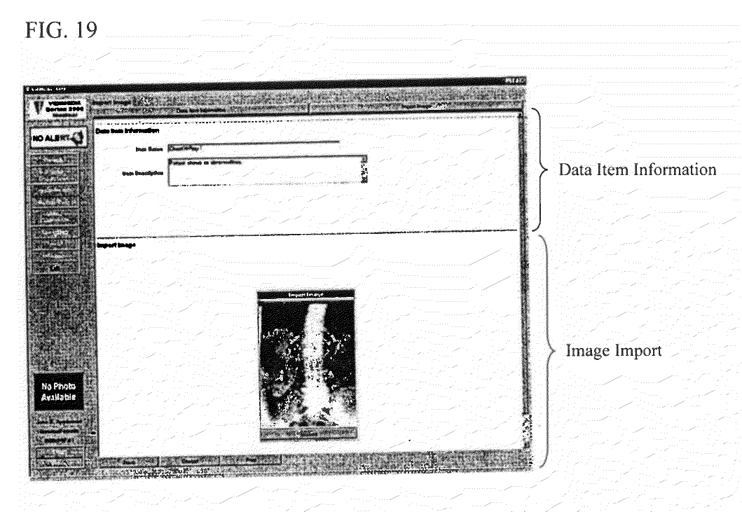

FIG. 19 is an example illustration of an “Image Import” screen of the data I/O framework type, which has been dynamically generated using the methods described herein. Again, the same framework code is used to support an Import Image data I/O page. The only major difference between this and the Audio Note screen is the actual data I/O components used (Data Item Information and Import Image ASP pages) and the sequence presentation information in the database.

FIG. 20 is an example illustration of a screen of the data I/O framework type, where the page incorporates several system and user defined components, which has been dynamically generated using the methods described herein. In this example showing a client-specific “Patient Registration” page, the core display components (Patient Information & Image Capture components) are integrated with a user-provided HTML file to (Patient Registration component). Again, no change to the compiled code was necessary to generate this page. The user-provided Patient Registration component attempts to duplicate the actual paper forms used in the user's office.

FIG. 21 is an example illustration of the data I/O framework type, where the page incorporates system and user defined components, which has been dynamically generated using the methods described herein. The page here further imitates the actual paper form by eliminating the different section headers and dividing lines for the last four components. By configuring the sequence presentation not to include headers for each component, the display components are seamlessly “glued” together to present a singular form look. Image data may be particularly important to show visual status of patients, as in the case shown in FIG. 21 of a patient looking very ill.

For use in relation to the methods described in relation to FIGS. 9, 11, and 13, FIGS. 22-33 are flowcharts describing server actions taken for the dynamic generation of such presentations. The methods described in relation to FIGS. 22-33 are executed with software using ASCs on the application server. As mentioned above, the detailed embodiment described herein does not serve to limit the scope of the invention, but only to enable one skilled in the art how to practice the invention and to disclose the best mode thereof.

Function LoadActionObjects. FIG. 22 is a flowchart describing a method associated with Function LoadActionObjects. LoadActionObjects identifies the action objects associated with the named page to which the user logged on at the particular location has access. Output from the function is a collection that identifies the action objects with all the parameters required by the GUI software.

| INPUT | DESCRIPTION |
|---|---|
| PageName | symbolic name for page |
| UserId | logon user identifier |
| LocationId | location (client node) |
| | identifier |
| DisplayLanguageId | logon user display |
| | language identifier |
| SelectionValues | array of keyword and value |
| | pairs of information |
| | necessary to process the |
| | access rules of the action |
| | objects |

| OUTPUT | DESCRIPTION |
|---|---|
| List | collection of action |
| | objects and all the |
| | parameters describing the |
| | action object formatting |

The method is performed as described in the FIG. 22. With respect to step 2202, the following instructions may be performed:
SELECT <PageId>=PAGE_ID FROM Pages
WHERE PAGE_NAME=<PageName>
   With respect to steps 2204, 2206, and 2208, the following instructions may be performed:
SELECT AO.*, PAO.*, GTS.Text_String
FROM Action_Objects AS AO
INNER JOIN Page_Action_Objects AS PAO
   ON AO.Action_Object_ID=PAO.Action_Object_ID
INNER JOIN Gui_Text_Strings AS GTS
   ON AO.Text ID=GTS.Text_ID
WHERE PAO.Page_ID=<PageId>
   AND GTS.Language_ID=<DisplayLanguageId>
ORDER BY AO.Location_On_Page, PAO.Display_Order
   With respect to step 2214, the following instructions may be performed:
<StoredProcedureName>=“v2k_p_” & <PageId> & “_r_” & <AccessRuleId>
   With respect to step 2222, the List that is returned to the caller may include;
LocationOnPage
DisplayOrder
ActionObjectId
ActionObjectName
ActionType
Image
Label
URL
URLParameters
Launch
Target
Enabled

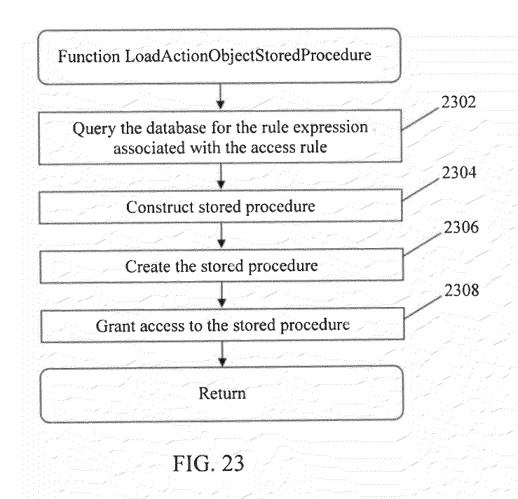

Function LoadActionObjectStoredProcedure. FIG. 23 is a flowchart describing a method associated with Function LoadActionObjectStoredProcedure. LoadActionObjectStoredProcedure builds the stored procedure that is an access rule associated with a given page. The UserId, LocationId, and DisplayLanguageId are automatically included as parameters to the stored procedure. Any other parameters required by the stored procedure must be supplied in the SelectionValues array.

| INPUT | DESCRIPTION |
|---|---|
| PageId | page identifier |
| UserId | logon user identifier |
| LocationId | location (client node) |
| | identifier |
| DisplayLanguageId | logon user display |
| | language identifier |
| AccessRuleId | access rule identifier |
| SelectionValues | array of keyword and value |
| | pairs of information |
| | necessary to process the |
| | access rules of the action |
| | objects |
| StoredProcedureName | name of stored procedure to |
| | be created |

| OUTPUT | DESCRIPTION |
|---|---|
| N/A | N/A |

The method is performed as described in FIG. 23. With respect to step 2302, the following instruction may be executed:
SELECT <RuleExpression>=Rule_Expression
FROM Rules WHERE Rule_ID=<AccessRuleId>
   With respect to step 2304, the following instructions may be executed:
<SqlString>=“CREATE PROC ” & <StoredProcedureName> & “(
   @@User_Id int, @@Location_Id int,
   @@Display_Language_Id int”
For Each element In SelectionValues
   <SqlString>=<SqlString> & “, @@” & <Keyword> & “varchar(255)”
Next
<SqlString>=<SqlString> & “) AS SET NOCOUNT ON” & <RuleExpression>
   With respect to step 2306,
Execute <SqlString>
   With respect to step 2308, the following instructions may be performed:
<SqlString>=“GRANT ALL ON” & <StoredProcedureName> &
   “TO” <DBUserName>
Execute <SqlString>
   With respect to FIG. 23 generally, an example is provided below under the heading “Example of LoadActionObjectStoredProcedure.”

Function GetListHeaders. FIG. 24 is a flowchart describing a method associated with Function GetListHeaders. GetListHeaders returns the column headings in the requested language for the table to be built.

| INPUT | DESCRIPTION |
|---|---|
| UserId | logon user identifier |
| LocationId | location (client node) |
| | identifier |
| DisplayLanguageId | logon user display language |
| | identifier |
| ContainerTypeName | name of the list to be displayed |
| SelectionValues | array of keyword and value pairs |
| | of information necessary to |
| | process the list |

| OUTPUT | DESCRIPTION |
|---|---|
| List | collection of list column |
| | headings information, including |
| | the display order and text |
| | string |

The method is performed as described in FIG. 24. With respect to step 2402, the following instruction may be performed:
SELECT <ContainerTypeId>=Container_Type_ID FROM Container_Types
WHERE Container_Type_Name=<ContainerTypeName>
   With respect to step 2404, the following instructions may be performed:
SELECT DISTINCT GTS.TEXT_STRING AS Column_Name,
Display_Order
FROM Container_List_Columns AS CLC
INNER JOIN Gui_Text_Strings AS GTS
   ON CLC.Text_ID=GTS.Text_ID
WHERE Container_Type_ID=<ContainerTypeId>
   AND Language_ID=<DisplayLanguageId>
ORDER BY Display_Order
   With respect to step 2408, the <List> that will be returned to the caller may include:
column heading text string
display order

Function GetListObjects. FIG. 25 is a flowchart describing a method associated with Function GetListObjects. GetListObjects returns an array containing all the information necessary to build the list presentation. Data is returned for each column with all the rows sorted into the proper order.

| INPUT | DESCRIPTION |
|---|---|
| UserId | logon user identifier |
| LocationId | location (client node) |
| | identifier |
| DisplayLanguageId | logon user display language |
| | identifier |
| ActionObjectName | name of the action object |
| | leading to the list display |
| ContainerTypeName | name of the list to be displayed |
| SelectionValues | array of keyword and value pairs |
| | of information necessary to |
| | process the list |

| OUTPUT | DESCRIPTION |
|---|---|
| List | collection representing a grid |
| | of the columns and rows in the |
| | list |

The method is performed as described in FIG. 25. With respect to step 2502, the following instruction may be performed:
SELECT <ActionObjectId>=Action_Object_ID FROM Action_Objects
WHERE Action_Object_Name=<ActionObjectName>
   With respect to step 2504, the following instruction may be performed:
SELECT <ContainerTypeId>=Container_Type_ID FROM Container_Types
WHERE Container_Type_Name=<ContainerTypeName>
   With respect to step 2506, the following instruction may be performed:
SELECT <ActionRuleId>=Rule_ID FROM Rules AS R
INNER JOIN Action_Objects AS AO
   ON AO.Action_Rule_ID=R.Rule_ID
WHERE AO.Action_Object_ID=<ActionObjectId>
   With respect to step 2508, the following instruction may be performed:
SELECT * FROM Container_List_Columns
WHERE Container_Type_ID=<ContainerTypeID>
ORDER BY Load_Order
   With respect to step 2514, the following instruction may be executed:
<StoredProcedureName>=“v2k_r_” & <ActionRuleID> & “_t_” & <ContainerTypeId> & “_c_” & <OrderId>
   With respect to step 2522, the following list will be returned to the caller based on <ColumnType>:
   if <ColumnType> is action object
include:
   ContainerId
   DisplayOrder
   ActionObjectName
   ActionObjectId
   Image
   Label
   DisplayFormat
   URL
   URLParameters
   Mode
   Launch
   Target
      else if <ColumnType> is label
include:
   DisplayOrder
   Image
   Label
   DisplayFormat

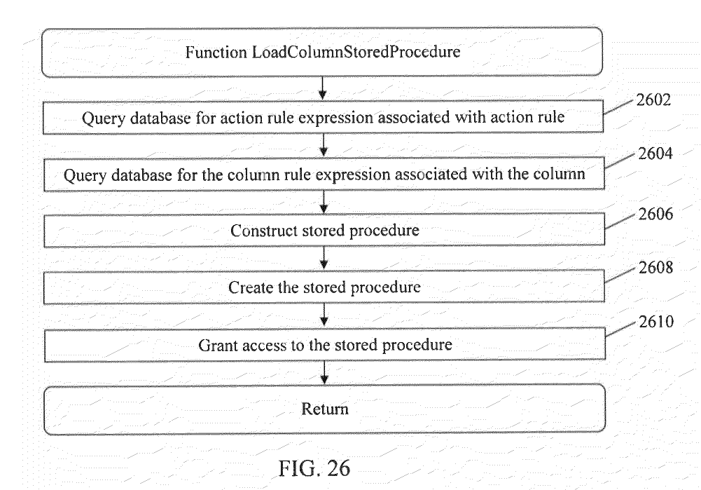

Function LoadColumnStoredProcedure. FIG. 26 is a flowchart describing a method associated with Function LoadColumnStoredProcedure. LoadColumnStoredProcedure builds the stored procedure that retrieves the column information for a list presentation. The UserId, LocationId and DisplayLanguageId are automatically included as parameters to the stored procedure. Any other parameters required by the stored procedure are supplied in the SelectionValues array.

| INPUT | DESCRIPTION |
|---|---|
| UserId | logon user identifier |
| LocationId | location (client node) |
| | identifier |
| DisplayLanguageId | logon user display language |
| | identifier |
| ContainerTypeId | list type identifier |
| OrderId | column order identifier |
| ActionRuleId | access rule identifier |
| SelectionValues | array of keyword and value pairs |
| | of information necessary to |
| | process the access rules of the |
| | action objects |
| StoredProcedureName | name of stored procedure created |

| OUTPUT | DESCRIPTION |
|---|---|
| N/A | N/A |

The method is performed as described in FIG. 26. With respect to step 2602, the following instruction may be executed:
SELECT <ActionRuleExpression>=Rule_Expression
FROM Rules WHERE Rule_ID=<ActionRuleId>
   With respect to step 2604, the following instruction may be executed:
SELECT <ColumnRuleExpression>=Column_Rule
FROM Container_List_Columns
WHERE CONTAINER_TYPE_ID=<ContainerTypeId>
   AND LOAD ORDER=“& <OrderID>
      With respect to step 2606, the following instructions may be executed:
<SqlString>=“CREATE PROC” & <StoredProcedureName> & (
   User_Id int, @@Location_Id int, @@Display_Language_Id int”
For Each element In <SelectionValues> <SqlString>=<SqlString>& “, @@” & <Keyword> & “varchar(255)”
Next
<SqlString>=<SqlString>& “) AS SET NOCOUNT ON”
<SqlString>=<SqlString>& “Create Table #t_Containers (Container ID int)”
<SqlString>=<SqlString>& “INSERT INTO #t_Containers (Container_ID)”
<SqlString>=<SqlString> & <ActionRuleExpression>
<SqlString>=<SqlString> & <ColumnRuleExpression>
   With respect to step 2608,
Execute <SqlString>
   With respect to step 2610, the following instruction may be executed:
<SqlString>=“GRANT ALL ON” & <StoredProcedureName> &
   “TO” <DBUserName>
Execute <SqlString>
   With respect to FIG. 26 generally, an example is provided below under the heading “Example of LoadColumnStoredProcedure.”

Function LoadLabels. FIG. 27 is a flowchart describing a method associated with Function LoadLabels. LoadLabels identifies the labels associated with the named page. Output from the function is an array that identifies the labels by their symbolic name and provides the text strings to the caller in the language requested.

| INPUT | DESCRIPTION |
|---|---|
| PageName | symbolic name for page |
| UserId | logon user identifier |
| LocationId | location (client node) |
| | identifier |
| DisplayLanguageId | logon user display language |
| | identifier |

| OUTPUT | DESCRIPTION |
|---|---|
| List | collection of labels that |
| | includes, the symbolic name and |
| | text string |

The method is performed as described in FIG. 27. With respect to step 2702, the following instructions may be performed:
SELECT PL.LABEL_NAME, GTS.TEXT_STRING
FROM PAGES AS P,
INNER JOIN PAGE LABELS AS PL
   ON P.PAGE_ID=PL.PAGE_ID
INNER JOIN GUI_LABELS AS GL
   ON PL.LABEL_NAME=GL.LABEL_NAME
INNER JOIN GUI_TEXT_STRINGS AS GTS
   ON GL.TEXT_ID=GTS.TEXT_ID
WHERE P.PAGE_NAME <PageName>
   AND GTS.LANGUAGE_ID=<DisplayLanguageId>
      With respect to step 2704, the <List> that will be returned to the caller may include:
label symbolic name
text string

Function GetDataFrames. FIGS. 28A and 28B are flowcharts describing a method associated with Function GetDataFrames. GetDataFrames returns an array containing all the information necessary to build a sequence presentation page. This information includes specifics about each of the data components including display information (display order, form tag, form, frame height, etc) as well as processing information (submit order, save action, cancel action, electronic signature required indicator, ASC name, data type identification, etc.)

| INPUT | DESCRIPTION |
|---|---|
| UserId | logon user identifier |
| LocationId | location (client node) |
| | identifier |
| DisplayLanguageId | logon user display language |
| | identifier |
| ActionObjectName | name of the action object |
| | leading to the sequence display |
| ContainerName | name of the parent data |
| | container to be displayed in the |
| | sequence |
| DisplaySequence | name of the display sequence |
| SelectionValues | array of keyword and value pairs |
| | of information necessary to |
| | process the data sequence |

| OUTPUT | DESCRIPTION |
|---|---|
| List | collection of data frame and |
| | associated data item information |

The method is performed as described in FIGS. 28A and 28B. With respect to step 2802, the following instruction may be performed:
SELECT <ActionObjectId>=Action_Object_ID FROM Action_Objects
WHERE Action_Object_Name=<ActionObjectName>
   With respect to step 2804, the following instruction may be performed:
SELECT <ContainerId>=Container_ID FROM Containers
WHERE Container_Name=<ContainerName>
   With respect to step 2806, the following instruction may be performed:
SELECT <SequenceId>=Sequence_ID FROM
Data_Item_Sequences
WHERE Sequence_Name=<DisplaySequence>
   With respect to step 2808, the following instructions may be performed:
SELECT DT.ASC_Object_Name, DISP.*, GTS.Text_String
FROM Data Item Sequence Pages AS DISP
INNER JOIN Data_Types AS DT
   ON DISP.Data_Type_ID=DT.Data_Type_ID
FULL OUTER JOIN Gui_Text_Strings AS GTS
   ON DISP.HTML_FORM_PAGE_TEXT_ID=GTS.Text_ID
WHERE DISP.Sequence_ID=<DisplaySequenceID>
   AND GTS.Language_ID IN (null, <DisplayLanguageId>)
UNION
SELECT ‘ ’ AS ASC_Object_Name, DISP.*, GTS.Text_String
FROM Data_Item_Sequence_Pages AS DISP
FULL OUTER JOIN Gui_Text_Strings AS GTS
   ON DISP. HTML_FORM_PAGE_TEXT_ID=GTS.Text_ID
WHERE DISP.Sequence_ID=<DisplaySequenceId>
   AND Data_Type_ID IS NULL
   AND GTS.Language_ID IN (null,
<DisplayLanguageId>)
ORDER BY Display_Order
   With respect to step 2812, the <List> that will be returned to the caller includes:
DisplayOrder
SubmitOrder
FormPageName
FormPageAnchor
FormPageLabel
FormPage
FormTag
FormSaveAction
FormCancelAction
FrameHeight
ElectronicSignatureRequired
ASCObjectName
DataTypeId
DataItemId
   With respect to step 2816 of FIG. 28B, the following instruction may be performed:
SELECT * FROM Action_Objects
WHERE Action_Object_ID=<ActionObjectId>
   With respect to step 2822 of FIG. 28B, the following instruction may be performed:
<StordProcedureName>=“v2k_r_” & <ActionRuleID> & “_s_” & <SequenceId>
   With respect to step 2832, this step updates the <DataItemID> of <List>.

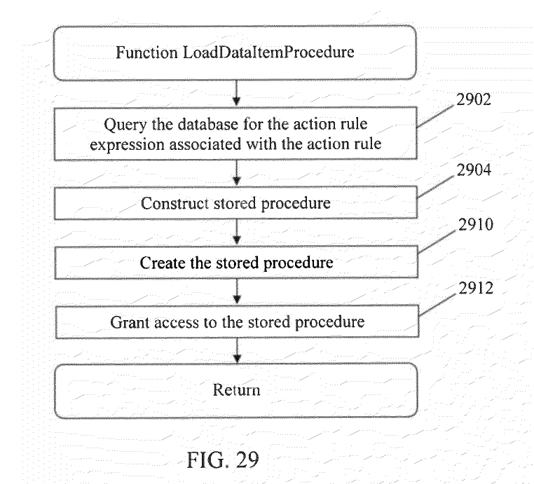

Function LoadDataItemsProcedure. FIG. 29 is a flowchart describing a method associated with Function LoadDataItemProcedure. LoadDataItemsProcedure builds the stored procedure that retrieves the identification of the data elements to be displayed in the sequence presentation. The UserId, LocationId and DisplayLanguageId are automatically included as parameters to the stored procedure. Any other parameters required by the stored procedure are supplied in the SelectionValues array.

| INPUT | DESCRIPTION |
|---|---|
| UserId | logon user identifier |
| LocationId | location (client node) |
| | identifier |
| DisplayLanguageId | logon user display language |
| | identifier |
| SequenceId | sequence identifier |
| ActionRuleId | action rule identifier |
| SelectionValues | array of keyword and value pairs |
| | of information necessary to |
| | process the access rules of the |
| | action objects |
| StoredProcedureName | name of stored procedure created |

| OUTPUT | DESCRIPTION |
|---|---|
| N/A | N/A |

The method is performed as described in FIG. 29. With respect to step 2902 of FIG. 29, the following instruction may be performed:
SELECT <ActionRuleExpression>=Rule_Expression
FROM Rules WHERE Rule_ID=<ActionRuleId>
   With respect to step 2904 of FIG. 29, the following instructions may be performed:
<SqlString>=“CREATE PROC ” & <StoredProcedureName> &
   “(@@User_Id int, @@Location_Id int,
   @@DisplayLanguage_Id int, @@Container_ID int”
For Each element In SelectionValues
   <SqlString>=<SqlString> & “, @@” & <Keyword> & “varchar(255)”
Next
<SqlString>=<SqlString> & “) AS SET NOCOUNT ON”
<SqlString>=<SqlString> &
   “SELECT C.Container_Type_Id, DO.Data_Item_Id, DI.Data_Type_ID
   FROM Data_Items AS DI
   INNER JOIN Data_Objects AS DO
      ON DI.Data_Item_ID=DO.Data_Item_ID
   INNER JOIN Containers AS C
      ON C.Container ID=DO.Container_ID
   WHERE DO.Container_ID (” & <ActionRuleExpression>& “)”
      With respect to step 2910,
Execute <SqlString>
   With respect to step 2912, the following instructions may be performed:
<SqlString>=“GRANT ALL ON” & <StoredProcedureName> & “TO” <DBUserName>
Execute <SqlString>

Function GetSelectorList. FIG. 30 is a flowchart describing a method associated with Function GetSelectorList. GetSelectorList identifies the values for the drop-down selector on the named page. The output of the function is a collection that contains the text strings to be displayed along with their internal identifiers.

| INPUT | DESCRIPTION |
|---|---|
| PageName | symbolic name for page |
| SelectorName | symbolic name for the selector |
| UserId | logon user identifier |
| LocationID | location (node) identifier |
| DisplayLanguageId | logon user display language |
| | identifier |

| OUTPUT | DESCRIPTION |
|---|---|
| List | collection of text strings with |
| | the internal identifiers |

The method is performed as described in FIG. 30. With respect to step 3002, the selector information retrieved includes an <ActionObjectArea>. The following instruction may be used:
SELECT SELECTOR_ID, ACTION_OBJECT_AREA.
FROM SELECTORS S, PAGES P, DYNAMIC_SELECTORS DS
WHERE PAGE_NAME=<PageName>
AND S.PAGE_ID=P.PAGE_ID
AND DS.PAGE_ID=P.PAGE_ID
AND SELECTOR NAME <SelectorName>

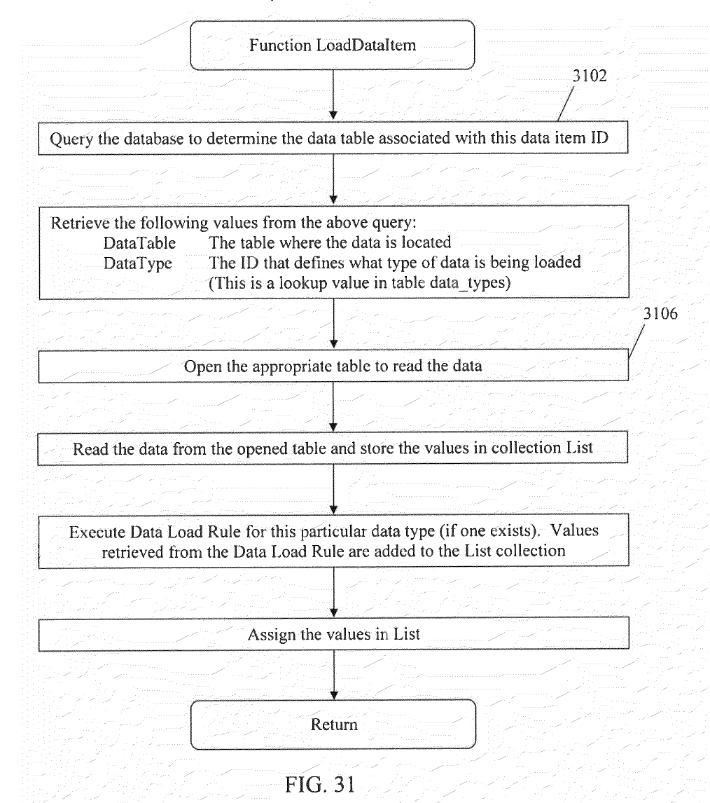

Function LoadDataItem. FIG. 31 is a flowchart describing a method associated with Function LoadDataItem. LoadDataItem retrieves the data associated with the passed in data item ID from the database. The function must determine the type of data to retrieve by querying the database for the appropriate table to load the data from. The output of this function is a collection of items retrieved for the passed in data item ID.

| INPUT | DESCRIPTION |
|---|---|
| DataItemID | The ID of the data item to load |

| OUTPUT | DESCRIPTION |
|---|---|
| ReturnList | The collection of data that was |
| | retrieved for this data item ID |

The method is performed as described in FIG. 31. With respect to step 3102, the following instructions may be used:
SELECT Data_Types.*
FROM Data_Types
INNER JOIN Data_Items ON Data_Types.Data_Type_ID=Data_Items.Data_Type_ID
WHERE Data_Item ID=<DataItemID>
   With respect to step 3106, the following instruction may be executed:
SELECT * FROM <DataTable>
WHERE DataItemID=<DataItemID>

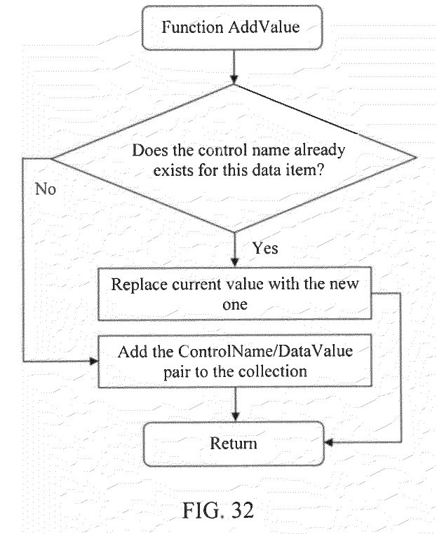

Function AddValue. FIG. 32 is a flowchart describing a method associated with Function AddValue. AddValue is called prior to a call to SaveNewDataItem or UpdateDataItem. It takes a name/value pair and adds it to the collection maintained inside the VMdata class. This function is called by either ASP's or COM's to add individual data elements to a data item.

| INPUT | DESCRIPTION |
|---|---|
| ControlName | The name associated with the |
| | data element; used for column |
| | name resolution |
| DataValue | The value of the data element; |
| | this value can be of any type |
| | handled by Visual Basic |

| OUTPUT | DESCRIPTION |
|---|---|
| N/A | N/A |

The method is performed as described in FIG. 32.

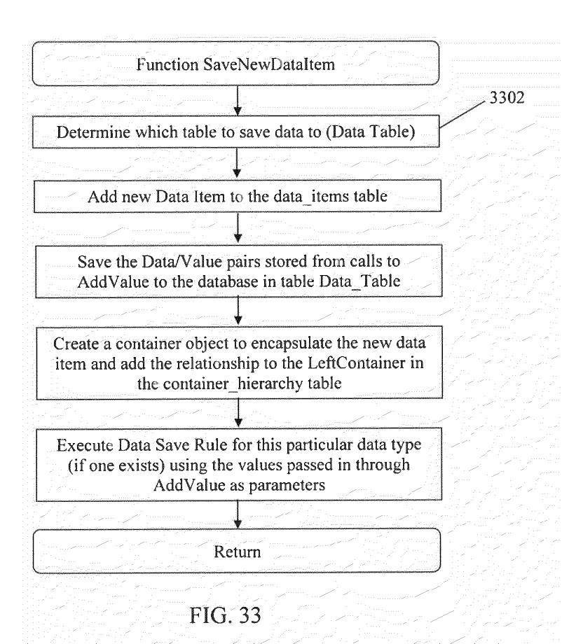

Function SaveNewDataItem. FIG. 33 is a flowchart describing a method associated with Function SaveNewDataItem. SaveNewDataItem saves the values passed in through AddValue as a single data item.

| INPUT | DESCRIPTION |
|---|---|
| LeftContainer | Left Container that will be |
| | associated with the new |
| | container created of type |
| DataType | The type of data being saved as |
| | defined in the data_types table |
| ContainerType | Container type of the new data |
| | item being saved as defined in |
| | the table container_types |

| OUTPUT | DESCRIPTION |
|---|---|
| N/A | N/A |

The method is performed as described in FIG. 33. With respect to step 3302, the following instruction may be executed:
SELECT * FROM Data_Types
WHERE Data_Type_ID=<DataTypeID>

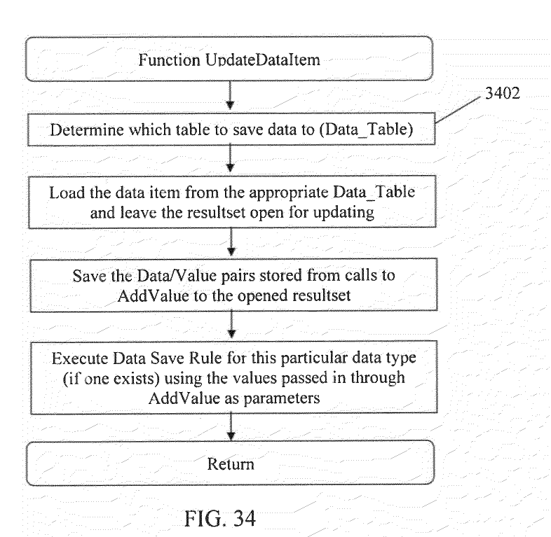

Function UpdateDataItem. FIG. 34 is a flowchart describing a method associated with Function UpdateDataItem. UpdateDataItem saves the values to passed in through AddValue as a single data item. This function assumes that the data item has already been saved at some previous time.

| INPUT | DESCRIPTION |
|---|---|
| DataItemID | Data Item to update |

| OUTPUT | DESCRIPTION |
|---|---|
| N/A | N/A |

The method is performed as described in FIG. 34. With respect to step 3402, the following instructions may be executed:
SELECT Data_Types.* FROM Data_Types
INNER JOIN Data_Items ON Data_Types.Data_Type_ID=DataItems.Data_Type_ID
WHERE Data_Item_ID=<DataItemID>

Example of LoadActionObjectStoredProcedure. A clinical user has logged on to the system that results in a request for the CLINICAL_USER_HOME page. All action objects for this page are identified:
PageName=CLINICAL_USER_HOME
PageId=19

| | | | Display | |
|---|---|---|---|---|
| ActionObjectId | ActionObjectName | LocationOnPage | Order | ActionRule [symbol] |
| 151 | AO_Clinical_Patient_List | Standard | 1 | 14 |
| | | Navigation | | |
| 475 | Add Clinic1 Patient | Standard | 2 | 356 |
| | | Navigation | | |
| 485 | Add Clinic2 Patient | Standard | 2 | 363 |
| | | Navigation | | |
| 494 | Add Clinic3 Patient | Standard | 2 | 369 |
| | | Navigation | | |
| 503 | Add TRC Patient | Standard | 2 | 377 |
| | | Navigation | | |
| 527 | Add Gladstone Patient | Standard | 2 | 385 |
| | | Navigation | | |
| 539 | Add TBI Patient | Standard | 2 | 395 |
| | | Navigation | | |
| 9 | Schedule List | Standard | 3 | 10 |
| | | Navigation | | |
| 10 | Add Appointment | Standard | 4 | 16 |
| | | Navigation | | |
| 11 | Video Conference | Standard | 5 | 10 |
| | | Navigation | | |
| 12 | Alerts | Standard | 6 | 10 |
| | | Navigation | | |
| 5 | Clincial User Nav Home | Standard | 7 | 14 |
| | | Navigation | | |
| 14 | Configuration | Standard | 8 | 10 |
| | | Navigation | | |

[symbol]

indicates data missing or illegible when filed

Each action object in the list above will be evaluated to determine whether the resulting page will include the functionality represented by the action object. As an example of this evaluation, consider whether the user will be able to view the AO_Clinical_Patient_List action object.

A stored procedure is created which, when executed, will determine if the user has access or not. The access rule associated with the action object is:
AccessRuleId=14
AccessRuleName=Is User Not In Admin Group
AccessRuleExpression=
SELECT GCH.Left_container_ID
FROM Container_Hierarchy AS UCH
INNER JOIN Container_Hierarchy AS GCH
   ON UCH.Right_Container_ID=GCH.Left_Container_ID
INNER JOIN Data_Objects
   ON GCH.Right_Container_ID=Data_Objects.Container_ID
INNER JOIN Groups
   ON Groups.Data_Item_ID=Data_Objects.Data_Item_ID
WHERE Groups.Group_Name< >“Administration”
AND UCH.left_container_ID=@@User_ID

This access rule determines whether the user logged on the system (@@User_ID) is in a group named ‘Administration’. If not, access is granted. Otherwise, access will be-denied.

A stored procedure named v2k_p_{—}19_r_{—}14 is programmatically created. The ‘p_{—}19’ is for pageid 19 and ‘r_{—}14’ is for access rule 14. The following is the body of the actual stored procedure:

if exists (select * from sysobjects where id=object_id(‘sqluser.v2k_p_19_r_14’) and sysstat & 0×f=4) drop procedure sqluser.v2k_p_19_r_14

### GO

CREATE PROC v2k_p_19_r_{—}14 (@@User_ID INT, @@Location_ID int, @@Display_Language_ID int) AS SET NOCOUNT ON SELECT GCH.Left_container_ID

### FROM Container_Hierarchy AS UCH

INNER JOIN Container_Hierarchy AS GCH ON UCH. Right_Container_ID=GCH.Left_Container_ID
INNER JOIN Data_Objects ON GCH.Right_Container ID=Data_Objects. Container_ID
INNER JOIN Groups ON Groups.Data_Item_ID—Data_Objects.Data_Item_ID
   WHERE Groups.Group_Name<>‘‘Administration’ AND UCH.left_container_ID=@User_ID

### GO

GRANT EXECUTE ON sqluser.v2k_p_19_r_{—}14 TO sqluser

### GO

Example of LoadColumnStoredProcedure. A user selects an action object on the page they are currently viewing. This action object leads to the display of another page that includes a list presentation.

Selection of the action object named ‘AO_Active_User_Patient_B’ is an example. This is the B tab in the A-Z presentation on the patient list. Clicking on ‘B’ leads to a list display of all the active patients whose last name begins with B, to which the clinical user has access.

The action object is defined as:
ActionObjectId=181
ActionObjectName=AO_Active_User_Patient_B
ActionRuleId=138
ActionRuleName=Select Active User B Patients
ActionRuleExpression=exec vmxsp_patient_list @@User_ID, “B”, “USER”, “ACTIVE”
URL=vm_list_display.asp
URL_Parameters=CT=CT_Patient_List

This action object navigates to the ‘vm_list_display.asp’ with a parameter to indicate the ContainerType of the list to be displayed is ‘CT_Patient_List’. The container type controls the columns displayed. The action rule controls the rows displayed.

The action rule in this case is an invocation of pre-existing stored procedure named ‘vmxsp_patient_list’ which is defined in the following. The following stored procedure ‘vmxsp_patient_list’ demonstrates the complexity of the rules that the system supports:
exists (select * from sysobjects where id=ject_id(‘dbo.vmxsp_patient_list’) and sysstat & 0xf=4)
   drop procedure dbo.vmxsp_patient_list
EATE PROC vmxsp_patient_list(@user_id int, @letter char, @filter rchar(10), @status varchar(10))
T NOCOUNT ON
clare @likestring varchar(30)
lect @likestring=@letter+‘%’
EATE TABLE #t_patients (container_id int)
   @filter=‘USER’
BEGIN
   INSERT INTO #t_patients (container_id)
   SELECT distinct v1.Right_Container_ID FROM right_cont_hierarchy_type as v1
      INNER JOIN v_left_cont_hierarchy_type AS v2
         ON v2.Left_Container_ID=v1.Left_Container_ID
      INNER JOIN v_right_cont_hierarchy_type AS v3
         ON v3.Right_Container_ID=v2.Right_Container_ID
      INNER JOIN Container_Hierarchy AS CH4
         ON CH4.Left_Container_ID=v1.Right_Container_ID
      INNER JOIN Data_Objects AS DOBJ
         ON CH4.Right_Container_ID=DOBJ.Container_ID
      INNER JOIN Personal_Information AS PI
         ON PI.Data_Item_ID=DOBJ.Data_Item_ID
      WHERE v1.Right_Container_Type_Name=‘CT_Patient’
         AND v2.Left_Container_Type_Name=‘CT Relation:
         AND v3.Right_Container_Type_Name=‘CT Group’
         AND v3.Left_Container_ID=@User_ID
         AND PI.Sur_Name LIKE @likestring
         AND CH4.Delete_Status=0
UNION
SELECT distinct v1.Left_container_ID FROM v_cont_hierarchy_and_types as v1
   INNER JOIN v_left_cont_hierarchy_type AS v2
      ON v2.Right_Container_ID=v1.Right_Container_ID
   INNER JOIN v_right_cont_hierarchy_type AS v3
      ON v3.Left_Container_ID=v2.Left_Container_ID
   INNER JOIN Container_Hierarchy AS CH4
      ON CH4.Right_Container_ID=v3.Right_Container_ID
   INNER JOIN Container_Hierarchy AS CH5
      ON CHS.Left_Container_ID=v1.Left_Container_ID
   INNER JOIN Data_Objects AS DOBJ
      ON CH5.Right_Container_ID=DOBJ.Container_ID
   INNER JOIN Personal_Information AS PI
      ON PI.Data_Item_ID=DOBJ.Data_Item_ID
   WHERE v1.Right_Container_Type_Name=‘CT_Telemedicine_Appointment’
      AND v1.Left_Container_Type_Name=‘CT_Patient’
      AND v2.Left_Container_Type_Name=‘CT_Relationship’
      AND v3.Right_Container_Type_Name=‘CT_Group’
      AND CH4.Left_Container_ID=@User_ID
      AND PI.Sur_Name LIKE @likestring
      AND CH4.Delete_Status=0
      AND CH5.Delete_Status=0
END
else
BEGIN
   INSERT INTO #t_patients (container_id)
   SELECT distinct v.Left_container_ID FROM v_left_cont_hierarchy_type as v
      INNER JOIN Data_Objects AS DOBJ
         ON v.Right_Container_ID=DOBJ.Container_ID
      INNER JOIN Personal_Information AS PI
         ON PI.Data_Item_ID=DOBJ.Data_Item_ID
      WHERE v.Left_Container_Type_Name=‘CT_Patient’
         AND PI.Sur_Name LIKE @likestring
END
if (@status < > ‘ALL’)
BEGIN
   SELECT TPT.Container_ID FROM #t_patients AS TPT
      INNER JOIN Container_Hierarchy AS CH
      ON CH.Left Container_ID=TPT.Container_ID
      INNER JOIN Data Objects AS DOBJ
         ON CH.Right_Container_ID=DOBJ.Container_ID
      INNER JOIN Patients AS PT
         ON PT.Data_Item_ID=DOBJ.Data_Item_ID
      INNER JOIN Single_Value_Lists AS SVL
         ON SVL.List_Entry_ID=PT.Status
      WHERE SVL.List_Name=‘Patient_Status’
         AND SVL.Symbolic_Name IN (@status)
         AND CH.Delete_Status=0
END
else
BEGIN
   SELECT TPT.Container_ID FROM #t_patients AS TPT
END
RETURN
GO
   The list type displayed for the patient list is:
ContainerTypeId=11
ContainerTypeName=CT_Patient_List
LoadOrder=1
ColumnRuleExpression=
   SELECT (
      Given_Name+“ ”+Middle_Name+“ ”+Sur_Name +“”+Suffix) AS Label,
      NULL AS Image,
      Container_Hierarchy.Left_Container_ID AS
Container_ID
   FROM Personal_Information
      INNER JOIN Data_Objects AS Data_Objects
         ON Personal_Information.Data_Item ID=
      Data_Objects.Data_Item_ID
      INNER JOIN Container_Hierarchy AS
Container_Hierarchy
   ON Data_Objects.Container_ID
      Container_Hierarchy.Right_Container_ID
      INNER JOIN #t_Containers
         ON #t_Containers.Container_ID=
      Container_Hierarchy.Left_Container_ID
      ORDER BY Sur_Name, Given_Name

A stored procedure named v2k_r_{—}138_t_{—}11_c_{—}1 is programmatically created. The ‘r_{—}138’ is for action rule id of the action object, ‘t_{—}11’ is the container type id for ‘CT_Patient_List’ and ‘c_{—}1’ is the first column loaded to build the table. The following is the body of the actual stored procedure:

if exists (select * from sysobjects where id=object_id(‘sqluser.v2k_r_{—}138_t_{—}11_c_{—}1’) and sysstat & 0×f=4) drop procedure sqluser.v2k_r_{—}138_t_{—}11_c_{—}1

### GO

CREATE PROC v2k_r_{—}138_t_{—}11_c1(@@User_ID int, @@Location_ID @@Display_Language_ID int) AS SET NOCOUNT ON Create Table #t_Containers
(

### Container_ID int

INSERT INTO #t_Containers (Container_ID)
exec vmxsp_patient_list @@User_ID, ‘B’, ‘USER’, ‘ACTIVE’

### SELECT (Given_Name+‘‘+Middle_Name+‘‘+Sur_Name+‘‘+Suffix) AS Label,

NULL AS Image,
Container_Hierarchy. Left_Container_ID AS Container_ID
FROM Personal_Information
INNER JOIN Data_Objects AS Data_Objects.ON Personal_Information.Data_Item_ID=Data_Objects.Data_Item_ID
INNER JOIN Container_Hierarchy AS Container_Hierarchy ON Data_Objects.Container_ID=Container_Hierarchy.Right_Container
INNER JOIN #t_Containers ON #t_Containers.Container_ID=Container_Hierarchy.Left_Container_ID
ORDER BY Sur_Name, Given_Name

### GO

GRANT EXECUTE ON sqluser.v2k_r_{—}138_t_{—}11_c_{—}1 TO sqluser

### GO

Alert Notification Subsystem. Alert notifications are available in the system, and are configurable using similar “rules”. A particular embodiment of alert notification and configurability is described below.

| Feature | Implementation |
|---|---|
| System allows a user to send | Adhoc Alert |
| an alert message to other | |
| user(s). | |
| System notifies user(s) of | Auto Alert |
| action objects events | |
| initiated by another user. | |
| Alert is presented via audio | Audio/Visual Alert |
| and/or visual signals at | |
| specified time interval based | |
| on priority. | |
| Alert is able to include data | Alert Data |
| items that can be viewed via | |
| action object mechanism. | |
| Alert is enabled based on | Alert Rule |
| predefined rule. | |
| Alert is sent to predefined | Alert User Rule |
| group(s) or user(s) based on | |
| alert user rule. | |
| Alert message is intelligently | Alert Message Template |
| generated based on system | |
| states. | |

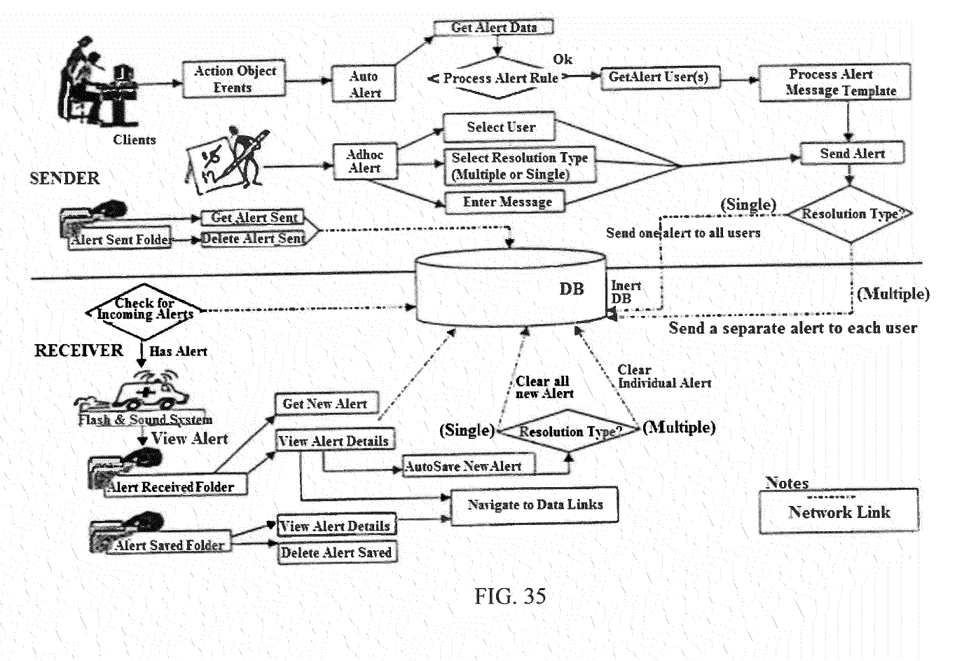

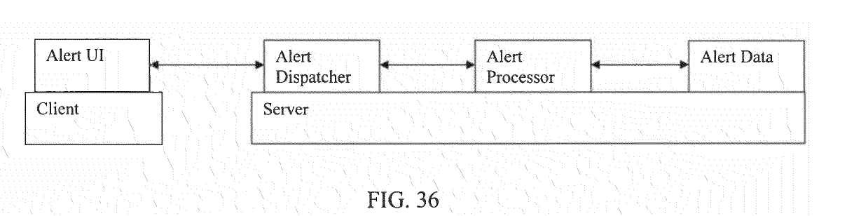

The general overall architecture and functionality for the alert subsystem is represented in FIG. 35. The general design of the alert subsystem is represented in FIG. 36. As shown in FIG. 36, the alert subsystem is composed of four main components: the Alert User Interface (UI); the Alert Dispatcher; the Alert Processor; and the Alert Data. Each component is separated from each other by the technology and functional capabilities that it encapsulates.

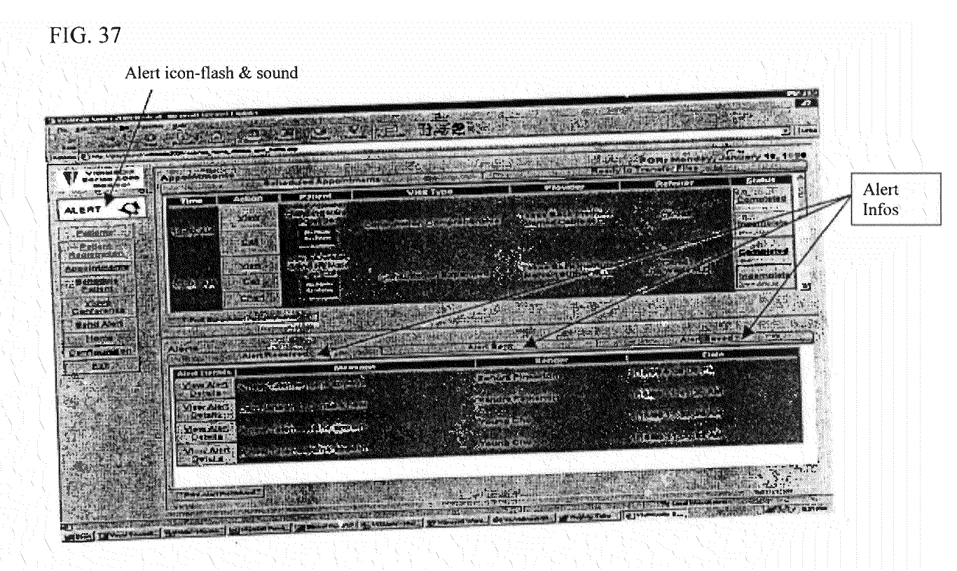

Alert User Interface (UI). FIG. 37 shows an example illustration of the Alert UI. The Alert UI encapsulates the visual and audio presentation solution for the alert. It uses many of today's most advanced browser technology such as ActiveX, HTML, DHTML, Java, Javascript, and VB Script to provide the most efficient and flexible solution interfacing user interaction with the alert. From the time a user logs on to the system to the time of log off, the Alert UI component tracks all alerts pertaining to that user and notifies the user appropriately of any incoming alert by a combination of sight and sound signals. Incoming and outgoing alerts are automatically saved until they are deleted by the user. When an action object is clicked on by the user, the underlying automatic alert UI component navigates the DHTML hierarchy to collect all of the contextual information for the alert generation process. The contextual information is important for the generation of intelligent automatic alerts.

Alert Dispatcher. When the Alert UI component completes its client's services, it sends a request to the appropriate server side Alert Dispatcher to handle the alert processing. The Alert Dispatcher is made up mostly of ASP pages that call the appropriate Alert Processor Interface based on the contextual information provided by the Alert UI component. The alert dispatch may be configured as part of the sequence presentation.

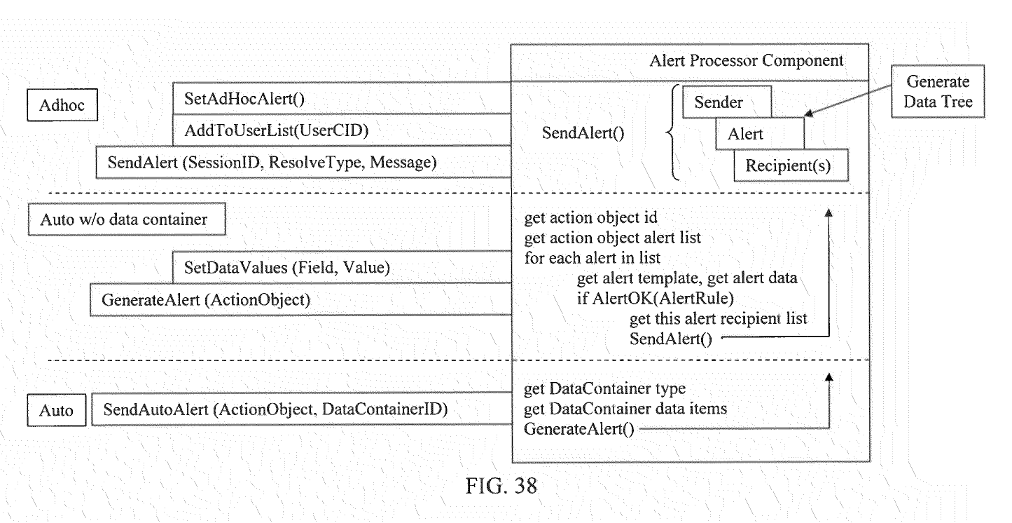

Alert Processor. When the Alert Processor is called, it processes all the contextual information to determine the user, the message, and the conditions for the alert. The Alert Processor interfaces with the database to obtain alert data for the alert(s) associated with the action object, the template for the alert, and the alert rule(s) for alert activation. The Alert Processor exposes three main public function interfaces to the Alert Dispatcher for sending alerts. The interfaces and processes are represented in FIG. 38.

An important aspect of the Alert Processor component is the configurable method of generating alert messages and determining the alert criteria for the appropriate activation conditions and recipients. In order to include data in the body of a message, the alert template embeds field data in <! !> symbols. To determine the alert criteria for alert activation, the alert rule requires that embedded field data and conditional logic be surrounded by keywords and symbols. The required keywords, symbols, and their definitions for the alert rule text are as follows:

| Keywords & Symbols | Definitions |
|---|---|
| <! !> | Must surround an alert field |
| | name |
| @user | Denotes current user who is |
| | initiating the action object. |
| ( ) | Must surround an alert rule |
| | statement |
| #AND# | Denotes AND logic |
| #OR# | Denotes OR logic |
| ₌ | Denotes Equality |
| <> | Denotes Inequality |
| > | Denotes Greater than |
| < | Denotes Less than |
| \| | Denotes Inclusive OR |
| ~ | Denotes Between |
| TRUE | Denotes Boolean - TRUE |
| | condition |
| FALSE | Denotes Boolean - FALSE |
| | condition |

Alert Data. The Alert Data component is composed of a set of data and tables residing in the database. The structure of the alert allows the association of action objects with alert templates and users. Alert data is generated when the SendAlert( ) function in the Alert Processor is called.

Alert Configuration. This section explains how an automatic alert can be enabled for an action object. The steps to configure an automatic alert for an action object are as follows:

1. Create a rule to identify the user(s) to receive the automatic alert.
For example, the following rule selects the users with logon names of ‘Taylor’ or ‘Sorrels’:
is SELECT PIC.Left_container_ID as container_id
FROM Users
   INNER JOIN Data_Objects AS PID
      ON Users.Data_Item_ID=PID.Data_Item_ID
   INNER JOIN Container_Hierarchy AS PIC
      ON PIC.Right_Container_ID=PID.Container_ID
   INNER JOIN Containers
      ON ContainersContainer_ID=PIC.Left_Container_ID
   INNER JOIN Container_Types
      ON Containers.Container_Type_ID=Container_Types.Container_Type_ID
WHERE Users.Logon Name in (“Taylor”, “Sorrels”)
   AND container_types.Container_Type_Name=“CT_User”
      2. Create an alert data rule to associate data with the alert.
For example, the following data rule selects a data element named ‘X-Ray’ with a date of today for the patient identified by @PatientId:
SELECT XRAY.Left_container_ID as container_id
FROM Container_Hierarchy as XRAY
   INNER JOIN Data_Objects AS XRAYDO
      ON XRAYDO.Container_ID=XRAY.Right_Container_ID
   INNER JOIN Container_Description AS XRAYCD
      ON XRAYCD.Data_Item_ID=XRAYDO.Data_Item_ID
   INNER JOIN Container_Hierarchy AS PAT
      ON PAT.Right_Container_ID=XRAY. Left_Container_ID
WHERE XRAYCD.Name=“X-Ray”
   AND XRAYCD.Creation Date Time>=convert(datetime, getdate( ), 1)
   AND PAT.Left_Container_ID=@PatientId
      3. Create an alert rule to define the alert activation criteria.
For example, the following rule sends an automatic alert when the message text included ‘Dr’ and ‘Order’:
(<!Name_TEXT!>|Dr) #AND# (<!Name_TEXT!>|Order) #AND#
(<!ACTION_MODE!>=EDIT) #AND#
(<!PROVIDER_USER_ID_VALUE!>>0) #AND#
(<!SCHEDULED_DATE_TEXT!>=#OR#
<!SCHEDULED_TIME_TEXT!>=#OR#
<!REFERRER_PRIORITY_ID_VALUE!>=)
   4. Associate the alert user rule, alert data rule, alert rule, and alert template with an alert definition in the Alert Data Component.
AlertName=Dr Order Alert Definition
AlertUserRule=Alert_User_Rule_ID
AlertDataRule=Alert_Data_Rule_ID
AlertRuleId=Alert_Rule_ID
AlertTemplate=
   <!PERSONAL_INFORMATION.SUR_NAME!>
   <!PERSONAL_INFORMATION.GIVEN_NAME!>
   <!PERSONAL_INFORMATION.SUFFIX!> has orders pending from <!@user. PERSONAL_INFORMATION.SUR_NAME!>
   <!@user.PERSONAL_INFORMATION.GIVEN_NAME!>
   <!@user.PERSONAL_INFORMATION.SUFFIX!>.
      5. Associate the alert definition with an action object.
AlertName=Dr Order Alert Definition
AlertId=8
ActionObjectName=Save Text Button
ActionObjectId=452

Scope of the Invention/Other Embodiments. Although the invention has been described in reference to specific embodiments, the description is not meant to be construed in a limiting sense. Various modifications of the disclosed embodiment, as well as alternative embodiments of the invention will become apparent to persons skilled in the art upon reference to the description. It is therefore contemplated that the appended claims will cover such modifications that fall within the true spirit and scope of the invention.

### Appendix A: Tables

TABLE
ACTION_OBJECT_ALERTS
Columns

| Name | Type | Siz [symbol] |
|---|---|---|
| ACTION_OBJECT_ID | Number (Long) | 4 |
| ALERT_ID | Number (Long) | 4 |

[symbol]

indicates data missing or illegible when filed

TABLE
ACTION_OBJECTS
Columns

| Name | Type | Si [symbol] |
|---|---|---|
| ACTION_OBJECT_ID | Number (Long) | 4 |
| ACTION_OBJECT_NAME | Text | 50 |
| ACCESS_RULE_ID | Number (Long) | 4 |
| ACTION_RULE_ID | Number (Long) | 4 |
| TEXT_ID | Number (Long) | 4 |
| CONTAINER_TYPE_ID | Number (Long) | 4 |
| ACTION_TYPE | Text | 30 |
| URL | Text | 50 |
| URL_PARAMETERS | Text | 255 |
| TARGET | Text | 255 |
| IMAGE | Text | 255 |
| LAUNCH | Text | 20 |
| ACTION_OBJECT_ANNOTATION | Memo | — |

[symbol]

indicates data missing or illegible when filed

TABLE
ALERTS
Columns

| Name | Type | S [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| ALERT_DATETIME | Date/Time | 8 |
| RESOLVE_DATETIME | Date/Time | 8 |
| PRIORITY_ID | Number (Long) | [symbol] |
| STATUS_ID | Number (Long) | [symbol] |
| SEND_TO | Memo | [symbol] |
| RESOLVED_BY | Number (Long) | [symbol] |

[symbol]

indicates data missing or illegible when filed

TABLE
AUDIO_DATA
Columns

| Name | Type | Siz [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Text | 255 |
| VERSION_ID | Number (Long) | 4 |

[symbol]

indicates data missing or illegible when filed

TABLE
AUDITING
Columns

| Name | Type | Si [symbol] |
|---|---|---|
| DATA_TABLE | Text | 30 |
| AUDIT_DATA_TABLE | Text | 30 |
| AUDIT | Yes/No | 1 |
| DELETE_STATUS | Number (Long) | 4 |

[symbol]

indicates data missing or illegible when filed

TABLE
AUTOMATIC_ALERT_DEFINITIONS
Columns

| Name | Type | Si [symbol] |
|---|---|---|
| ALERT_ID | Number (Long) | 4 |
| ALERT_NAME | Text | 50 |
| DYNAMIC_MESSAGE | Memo | — |
| USER_LIST_RULE_ID | Number (Long) | 4 |
| DATA_LIST_RULE_ID | Number (Long) | 4 |
| ALERT_RULE_ID | Number (Long) | 4 |
| RESOLVE_TYPE | Number (Long) | 4 |

[symbol]

indicates data missing or illegible when filed

TABLE
CLIENT_APPLICATION_PARAMETERS
Columns

| Name | Type | Siz [symbol] |
|---|---|---|
| APPLICATION_ID | Number (Long) | 4 |
| KEYWORD | Text | 50 |
| KEYPATH | Text | 255 |
| VALUE | Text | 255 |
| TYPE | Text | 20 |

[symbol]

indicates data missing or illegible when filed

TABLE
CLIENT_APPLICATIONS
Columns

| Name | Type | Siz [symbol] |
|---|---|---|
| APPLICATON_ID | Number (Long) | 4 |
| APPLICATION_NAME | Text | 50 |
| DIRECTORY | Text | 255 |
| EXECUTABLE_NAME | Text | 255 |
| COMMAND_LINE | Text | 255 |

[symbol]

indicates data missing or illegible when filed

TABLE
CLIENT_PRODUCTS
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| PRODUCT_TYPE | Text | 80 |
| PRODUCT_NAME | Text | 80 |
| MANUFACTURER | Text | 80 |
| VERSION | Text | 20 |
| SERIAL_NUMBER | Text | 50 |
| IN_USE | Yes/No | 1 |

[symbol]

indicates data missing or illegible when filed

TABLE
CONTAINER_CROSS_REFERENCE
Columns

| Name | Type | Siz [symbol] |
|---|---|---|
| LOCAL_CONTAINER_ID | Number (Long) | 4 |
| EXTERNAL_SYSTEM_ID | Number (Long) | 4 |
| EXTERNAL_CONTAINER_ID | Number (Long) | 4 |

[symbol]

indicates data missing or illegible when filed

TABLE
CONTAINER_DESCRIPTION
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| NAME | Text | 255 |
| DESCRIPTION | Memo | — |
| IMAGE | Text | 255 |

[symbol]

indicates data missing or illegible when filed

TABLE
CONTAINER_HIERARCHY
Columns

| Name | Type | Si [symbol] |
|---|---|---|
| LEFT_CONTAINER_ID | Number (Long) | 4 |
| RIGHT_CONTAINER_ID | Number (Long) | 4 |
| DELETE_STATUS | Number (Long) | 4 |

[symbol]

indicates data missing or illegible when filed

TABLE
CONTAINER_LIST_COLUMNS
Columns

| Name | Type | S [symbol] |
|---|---|---|
| CONTAINER_TYPE_ID | Number (Long) | [symbol] |
| TEXT_ID | Number (Long) | [symbol] |
| COLUMN_TYPE | Number (Long) | [symbol] |
| COLUMN_RULE | Memo | [symbol] |
| DISPLAY_ORDER | Number (Long) | [symbol] |
| LOAD_ORDER | Number (Long) | [symbol] |
| DISPLAY_FORMAT | Text | 5 [symbol] |

[symbol]

indicates data missing or illegible when filed

TABLE
CONTAINER_TYPES
Columns

| Name | Type | Siz [symbol] |
|---|---|---|
| CONTAINER_TYPE_ID | Number (Long) | 4 |
| CONTAINER_TYPE_NAME | Text | 50 |
| DIRECTORY_SERVICES | Yes/No | 1 |
| CLIENT_PATH_NAME | Text | 32 |
| SERVER_PATH_NAME | Text | 32 |
| DELETE_STATUS | Number (Long) | 4 |
| CONTAINER_TYPE_ANNOTATION | Memo | — |

[symbol]

indicates data missing or illegible when filed

TABLE
CONTAINERS
Columns

| Name | Type | Siz [symbol] |
|---|---|---|
| CONTAINER_ID | Number (Long) | 4 |
| CONTAINER_NAME | Text | 255 |
| CONTAINER_TYPE_ID | Number (Long) | 4 |
| DELETE_STATUS | Number (Long) | 4 |

[symbol]

indicates data missing or illegible when filed

TABLE
DATA_DEFAULT_RULES
Columns

| Name | Type | Si [symbol] |
|---|---|---|
| DATA_TYPE_ID | Number (Long) | 4 |
| FORM_RULE | Memo | — |

[symbol]

indicates data missing or illegible when filed

TABLE
DATA_ITEM_SEQUENCE_PAGES
Columns

| Name | Type | Siz [symbol] |
|---|---|---|
| SEQUENCE_ID | Number (Long) | 4 |
| DISPLAY_ORDER | Number (Long) | 4 |
| LEFT_CONTAINER_TYPE_ID | Number (Long) | 4 |
| RIGHT_CONTAINER_TYPE_ID | Number (Long) | 4 |
| DATA_TYPE_ID | Number (Integer) | 2 |
| SUBMIT_ORDER | Number (Long) | 4 |
| HTML_FORM_PAGE_NAME | Text | 50 |
| HTML_FORM_PAGE_ANCHOR | Text | 50 |
| HTML_FORM_PAGE_TEXT_ID | Number (Long) | 4 |
| HTML_FORM_PAGE | Text | 50 |
| HTML_FORM_TAG | Text | 50 |
| HTML_FORM_SAVE_ACTION | Text | 50 |
| HTML_FORM_CANCEL_ACTION | Text | 50 |
| FRAME_HEIGHT | Number (Long) | 4 |
| ELECTRONIC_SIGNATURE_REQUIRED | Yes/No | 1 |

[symbol]

indicates data missing or illegible when filed

TABLE
DATA_ITEM_SEQUENCES
Columns

| Name | Type | Si [symbol] |
|---|---|---|
| SEQUENCE_ID | Number (Long) | 4 |
| SEQUENCE_NAME | Text | 30 |
| ICON_PAGE | Number (Long) | 4 |
| SEQUENCE_ANNOTATION | Memo | — |

[symbol]

indicates data missing or illegible when filed

TABLE
DATA_ITEMS
Columns

| Name | Type | Si [symbol] |
|---|---|---|
| DATA_ITEM_ID | Number (Long) | 4 |
| DATA_TYPE_ID | Number (Integer) | 2 |
| CREATION_DATE_TIME | Date/Time | 8 |
| CREATOR_ID | Number (Long) | 4 |
| SOURCE_TYPE | Number (Byte) | 1 |
| SOURCE_ID | Number (Integer) | 2 |
| LOCKED_BY | Number (Long) | 4 |
| DELETE_STATUS | Number (Long) | 4 |

[symbol]

indicates data missing or illegible when filed

TABLE
DATA_LOAD_RULES
Columns

| Name | Type | Si [symbol] |
|---|---|---|
| DATA_TYPE_ID | Number (Long) | 4 |
| FORM_RULE | Memo | — |

[symbol]

indicates data missing or illegible when filed

TABLE
DATA_OBJECTS
Columns

| Name | Type | Si [symbol] |
|---|---|---|
| CONTAINER_ID | Number (Long) | 4 |
| DATA_ITEM_ID | Number (Long) | 4 |

[symbol]

indicates data missing or illegible when filed

TABLE
DATA_SAVE_RULES
Columns

| Name | Type | Si [symbol] |
|---|---|---|
| DATA_TYPE_ID | Number (Long) | 4 |
| FORM_RULE | Memo | — |

[symbol]

indicates data missing or illegible when filed

TABLE
DATA_TYPES
Columns

| Name | Type | S [symbol] |
|---|---|---|
| DATA_TYPE_ID | Number (Long) | 4 |
| DESCRIPTIVE_NAME | Text | 50 |
| TEXT_ID | Number (Long) | 4 |
| ICON | Text | 255 |
| ASC_OBJECT_NAME | Text | 255 |
| ASC_ICON_OBJECT_NAME | Text | 255 |
| DATA_TABLE | Text | 30 |
| ELECTRONIC_SIGNATURE_DEFAULT | Yes/No | 1 |
| DELETE_STATUS | Number (Long) | [symbol] |
| DATA_TYPE_ANNOTATION | Memo | [symbol] |

[symbol]

indicates data missing or illegible when filed

TABLE
DEVICES
Columns

| Name | Type | Siz [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DEVICE_TYPE | Text | 80 |
| DEVICE_NAME | Text | 80 |
| MANUFACTURER | Text | 80 |
| VERSION | Text | 20 |
| SERIAL_NUMBER | Text | 50 |
| IN_USE | Yes/No | 1 |

[symbol]

indicates data missing or illegible when filed

TABLE
DICOM_DATA
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Text | 255 |
| VERSION_ID | Number (Long) | 4 |

[symbol]

indicates data missing or illegible when filed

TABLE
DIRECTORY_STRUCTURE
Columns

| Name | Type | Siz [symbol] |
|---|---|---|
| DATA_TYPE | Text | 32 |
| TYPE | Number (Integer) | 2 |
| HOST | Text | 255 |
| PATH_NAME | Text | 255 |

[symbol]

indicates data missing or illegible when filed

TABLE
DOUBLE_VALUE_LISTS
Columns

| Name | Type | Siz [symbol] |
|---|---|---|
| LIST_ENTRY_ID | Number (Long) | 4 |
| LIST_NAME | Text | 30 |
| SYMBOLIC_NAME | Text | 30 |
| VALUE1_TEXT_ID | Number (Long) | 4 |
| VALUE2_TEXT_ID | Number (Long) | 4 |
| IMAGE | Text | 255 |
| DISPLAY_INDICATOR | Yes/No | 1 |
| DISPLAY_ORDER | Number (Integer) | 2 |

[symbol]

indicates data missing or illegible when filed

TABLE
DYNAMIC_SELECTORS
Columns

| Name | Type | Si [symbol] |
|---|---|---|
| SELECTOR_ID | Number (Integer) | 2 |
| ACTION_OBJECT_AREA | Text | 50 |
| DYNAMIC_ENTRY_ID | Number (Long) | 4 |
| DYNAMIC_TEXT_ID | Number (Long) | 4 |

[symbol]

indicates data missing or illegible when filed

TABLE
FORMATTED_TEXT_DATA
Columns

| Name | Type | Siz [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Text | 255 |
| VERSION_ID | Number (Long) | 4 |

[symbol]

indicates data missing or illegible when filed

TABLE
GROUPS
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| GROUP_NAME | Text | 255 |
| DESCRIPTION | Text | 255 |
| PRACTICE_TYPE_ID | Number (Integer) | 2 |

[symbol]

indicates data missing or illegible when filed

TABLE
GUI_LABELS
Columns

| Name | Type | Si [symbol] |
|---|---|---|
| LABEL_NAME | Text | 32 |
| TEXT_ID | Number (Long) | 4 |

[symbol]

indicates data missing or illegible when filed

TABLE
GUI_TEXT_ID
Columns

| Name | Type | S [symbol] |
|---|---|---|
| TEXT_ID | Text | 255 |
| TEXT_NAME | Text | 50 |

[symbol]

indicates data missing or illegible when filed

TABLE
GUI_TEXT_STRINGS
Columns

| Name | Type | Siz [symbol] |
|---|---|---|
| TEXT_ID | Text | 255 |
| LANGUAGE_ID | Number (Integer) | 2 |
| TEXT_STRING | Text | 255 |

[symbol]

indicates data missing or illegible when filed

TABLE
IMAGE_DATA
Columns

| Name | Type | Siz [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Text | 255 |
| VERSION_ID | Number (Long) | 4 |

[symbol]

indicates data missing or illegible when filed

TABLE
LANGUAGES
Columns

| Name | Type | Si [symbol] |
|---|---|---|
| LANGUAGE_ID | Number (Long) | 4 |
| LANGUAGE_NAME | Text | 15 |
| TEXT_ID | Text | 255 |

[symbol]

indicates data missing or illegible when filed

TABLE
LISTS
Columns

| Name | Type | Si [symbol] |
|---|---|---|
| LIST_NAME | Text | 30 |
| LIST_TABLE | Text | 30 |
| EDIT_LEVEL | Number (Integer) | 2 |
| DEFAULT_SYMBOLIC_NAME | Text | 30 |

[symbol]

indicates data missing or illegible when filed

TABLE
LOCATIONS
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| LOCATION_NAME | Text | 50 |
| LOCATION_DESCRIPTION | Text | 50 |
| STATUS | Number (Byte) | 1 |

[symbol]

indicates data missing or illegible when filed

TABLE
MEDICAL_RECORD_NUMBERS
Columns

| Name | Type | S [symbol] |
|---|---|---|
| DATA_ITEM_ID | Number (Long) | [symbol] |
| USER_ID | Number (Long) | [symbol] |
| LAST_MODIFIED_DATE_TIME | Date/Time | [symbol] |
| CREATION_DATE_TIME | Date/Time | [symbol] |
| SIGNED | Yes/No | [symbol] |
| MEDICAL_RECORD_NUMBER | Text | 3 [symbol] |
| MEDICAL_RECORD_DESCRIPTION | Text | 25 [symbol] |

[symbol]

indicates data missing or illegible when filed

TABLE
PAGE_ACTION_OBJECTS
Columns

| Name | Type | S [symbol] |
|---|---|---|
| PAGE_ID | Number (Long) | [symbol] |
| ACTION_OBJECT_ID | Number (Long) | [symbol] |
| DISPLAY_ORDER | Number (Long) | [symbol] |
| LOCATION_ON_PAGE | Text | 3 |
| FIRE_ACTION_RULE | Yes/No | [symbol] |

[symbol]

indicates data missing or illegible when filed

TABLE
PAGE_LABELS
Columns

| Name | Type | Si [symbol] |
|---|---|---|
| PAGE_ID | Number (Long) | 4 |
| LABEL_NAME | Text | 32 |

[symbol]

indicates data missing or illegible when filed

TABLE
PAGES
Columns

| Name | Type | Si [symbol] |
|---|---|---|
| PAGE_ID | Number (Long) | 4 |
| PAGE_NAME | Text | 50 |
| ASP_NAME | Text | 255 |

[symbol]

indicates data missing or illegible when filed

TABLE
PATIENTS
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| PRIMARY_PHYSICIAN_ID | Number (Long) | 4 |
| STATUS | Number (Integer) | 2 |

[symbol]

indicates data missing or illegible when filed

TABLE
PERSONAL_INFORMATION
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| SSN | Text | 11 |
| DOB | Text | 14 |
| SEX_ID | Number (Integer) | 2 |
| TITLES | Text | 100 |
| SUR_NAME | Text | 40 |
| GIVEN_NAME | Text | 40 |
| MIDDLE_NAME | Text | 40 |
| SUFFIX | Text | 10 |

[symbol]

indicates data missing or illegible when filed

TABLE:
RELATIONSHIPS
Columns

| Name | Type | S [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| RELATIONSHIP_NAME | Text | 25 [symbol] |

[symbol]

indicates data missing or illegible when filed

TABLE
RULES
Columns

| Name | Type | S [symbol] |
|---|---|---|
| RULE_ID | Number (Long) | [symbol] |
| RULE_NAME | Text | 5 [symbol] |
| RULE_EXPRESSION | Memo | [symbol] |
| RULE_ANNOTATION | Memo | [symbol] |

[symbol]

indicates data missing or illegible when filed

TABLE
SELECTORS
Columns

| Name | Type | Siz [symbol] |
|---|---|---|
| SELECTOR_ID | Number (Long) | 4 |
| PAGE_ID | Number (Long) | 4 |
| SELECTOR_NAME | Text | 32 |
| TYPE | Text | 20 |

[symbol]

indicates data missing or illegible when filed

TABLE
SESSIONS
Columns

| Name | Type | Si [symbol] |
|---|---|---|
| SESSION_ID | Number (Long) | 4 |
| USER_ID | Number (Long) | 4 |
| LOCATION_ID | Number (Long) | 4 |
| LOGON_TIME | Date/Time | 8 |
| LOGOFF_TIME | Date/Time | 8 |
| LAST_UPDATED | Date/Time | 8 |
| APPOINTMENT_ID | Number (Long) | 4 |
| CURRENT_PATIENT_ID | Number (Long) | 4 |

[symbol]

indicates data missing or illegible when filed

TABLE
SIMPLE_TABLE_SELECTORS
Columns

| Name | Type | Si [symbol] |
|---|---|---|
| SELECTOR_ID | Number (Integer) | 2 |
| LIST_NAME | Text | 30 |
| COLUMN_NAME | Text | 30 |

[symbol]

indicates data missing or illegible when filed

TABLE
SINGLE_VALUE_LISTS
Columns

| Name | Type | Siz [symbol] |
|---|---|---|
| LIST_ENTRY_ID | Number (Long) | 4 |
| LIST_NAME | Text | 30 |
| SYMBOLIC_NAME | Text | 30 |
| VALUE_TEXT_ID | Number (Long) | 4 |
| IMAGE | Text | 255 |
| DISPLAY_INDICATOR | Yes/No | 1 |
| DISPLAY_ORDER | Number (Integer) | 2 |

[symbol]

indicates data missing or illegible when filed

TABLE
STUDY_DATA
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| NUMBER_OF_ROWS | Number (Integer) | 2 |
| NUMBER_OF_COLUMNS | Number (Integer) | 2 |

[symbol]

indicates data missing or illegible when filed

TABLE
SYSTEM_CONFIGURATION
Columns

| Name | Type | Si [symbol] |
|---|---|---|
| KEYWORD | Text | 50 |
| VALUE | Text | 255 |

[symbol]

indicates data missing or illegible when filed

TABLE
SYSTEMS
Columns

| Name | Type | S [symbol] |
|---|---|---|
| SYSTEM_ID | Number (Integer) | 2 |
| SYSTEM_NAME | Text | 5 [symbol] |
| SYSTEM_TYPE | Text | 2 [symbol] |
| INSTALL_ID | Text | 5 [symbol] |

[symbol]

indicates data missing or illegible when filed

TABLE
TEXT_DATA
Columns

| Name | Type | Siz [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Memo | — |

[symbol]

indicates data missing or illegible when filed

TABLE
USERS
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| LOGON_NAME | Text | 32 |
| PASSWORD | Text | 50 |
| VERIFY_PASSWORD | Text | 50 |
| USER_TYPE_ID | Number (Integer) | 2 |
| STATUS | Number (Integer) | 2 |
| DISPLAY_LANGUAGE_ID | Number (Integer) | 2 |

[symbol]

indicates data missing or illegible when filed

TABLE
VIDEO_DATA
Columns

| Name | Type | Si [symbol] |
|---|---|---|
| DATA_ITEM_ID | Number (Long) | 4 |
| USER_ID | Number (Long) | 4 |
| LAST_MODIFIED_DATE_TIME | Date/Time | 8 |
| CREATION_DATE_TIME | Date/Time | 8 |
| SIGNED | Yes/No | 1 |
| DATA | Text | 255 |
| VERSION_ID | Number (Long) | 4 |

[symbol]

indicates data missing or illegible when filed

View: v_cont_hierarchy_and_types
Columns

| Name | Type | Siz [symbol] |
|---|---|---|
| left_container_id | Number (Long) | 4 |
| left_container_name | Text | 255 |
| Ieft_container_type_id | Number (Long) | 4 |
| left_container_type_name | Text | 50 |
| left_directory_services | Yes/No | 1 |
| left_client_path_name | Text | 32 |
| left_server_path_name | Text | 32 |
| left_container_type_anno | Memo | — |
| right_container_id | Number (Long) | 4 |
| right_container_name | Text | 255 |
| right_container_type_id | Number (Long) | 4 |
| right_container_type_name | Text | 50 |
| right_directory_services | Yes/No | 1 |
| right_client_path_name | Text | 32 |
| right_server_path_name | Text | 32 |
| riaht_container_type_anno | Memo | — |

[symbol]

indicates data missing or illegible when filed

View: v_containers_and_data_items
Columns

| Name | Type | Si [symbol] |
|---|---|---|
| container_id | Number (Long) | 4 |
| container_name | Text | 255 |
| oontainer_type_id | Number (Long) | 4 |
| data_item_id | Number (Long) | 4 |
| data_type_id | Number (Integer) | 2 |
| creation_date_time | Date/Time | 8 |
| creator_id | Number (Long) | 4 |
| source_type | Number (Byte) | 1 |
| source_id | Number (Integer) | 2 |
| locked_by | Number (Long) | 4 |

[symbol]

indicates data missing or illegible when filed

View: v_containers_and_types
Columns

| Name | Type | S [symbol] |
|---|---|---|
| contalner_id | Number (Long) | 4 |
| container_name | Text | 255 |
| container_type_id | Number (Long) | 4 |
| container_type_name | Text | 50 |
| directory_services | Yes/No | 1 |
| client_path_name | Text | 32 |
| server_path_name | Text | 32 |
| container_type_annotation | Memo | [symbol] |

[symbol]

indicates data missing or illegible when filed

View: v_data_items_and_data_types
Columns

| Name | Type | S [symbol] |
|---|---|---|
| data_item_id | Number (Long) | [symbol] |
| data_type_id | Number (Integer) | [symbol] |
| creation_date_time | Date/Time | [symbol] |
| creator_id | Number (Long) | [symbol] |
| source_type | Number (Byte) | [symbol] |
| source_id | Number (Integer) | [symbol] |
| locked_by | Number (Long) | [symbol] |
| descriptive_name | Text | 5 |
| text_id | Number (Long) | [symbol] |
| icon | Text | 25 |
| asc_object_name | Text | 25 |
| asc_icon_object_name | Text | 25 |
| data_table | Text | 3 |
| electronic_signature_default | Yes/No | [symbol] |
| data_type_annotation | Memo | [symbol] |

[symbol]

indicates data missing or illegible when filed

View: v_data_objects_and_data_items
Columns

| Name | Type | Siz [symbol] |
|---|---|---|
| container_id | Number (Long) | 4 |
| data_item_id | Number (Long) | 4 |
| data_type_id | Number (Integer) | 2 |
| creation_date_time | Date/Time | 8 |
| creator_id | Number (Long) | 4 |
| source_type | Number (Byte) | 1 |
| source_id | Number (Integer) | 2 |
| locked_by | Number (Long) | 4 |

[symbol]

indicates data missing or illegible when filed

View: v_data_objects_and_data_types
Columns

| Name | Type | Si [symbol] |
|---|---|---|
| container_id | Number (Long) | 4 |
| data_item_id | Number (Long) | 4 |
| data_type_id | Number (Integer) | 2 |
| creation_date_time | Date/Time | 8 |
| creator_id | Number (Long) | 4 |
| source_type | Number (Byte) | 1 |
| source_id | Number (Integer) | 2 |
| locked_by | Number (Long) | 4 |
| descriptive_name | Text | 50 |
| text_id | Number (Long) | 4 |
| icon | Text | 255 |
| asc_object_name | Text | 255 |
| asc_icon_object_name | Text | 255 |
| data_table | Text | 30 |
| electronic_signature_default | Yes/No | 1 |
| data_type_annotation | Memo | — |

[symbol]

indicates data missing or illegible when filed

View: v_left_cont_hierarchy_type
Columns

| Name | Type | Siz [symbol] |
|---|---|---|
| left_container_id | Number (Long) | 4 |
| right_container_id | Number (Long) | 4 |
| left_container_name | Text | 255 |
| left_container_type_id | Number (Long) | 4 |
| left_container_type_name | Text | 50 |
| left_directory_services | Yes/No | 1 |
| left_client_path_name | Text | 32 |
| left_server_path_name | Text | 32 |
| left_container_type_anno | Memo | — |

[symbol]

indicates data missing or illegible when filed

View: v_right_cont_hierarchy_type
Columns

| Name | Type | Siz [symbol] |
|---|---|---|
| left_container_id | Number (Long) | 4 |
| right_container_id | Number (Long) | 4 |
| right_container_name | Text | 255 |
| right_container_type_id | Number (Long) | 4 |
| right_container_type_name | Text | 50 |
| right_directory_services | Yes/No | 1 |
| right_client_path_name | Text | 32 |
| right_server_path_name | Text | 32 |
| right_container_type_anno | Memo | — |

[symbol]

indicates data missing or illegible when filed

We claim:

1. A method for dynamically generating a user interface for an application program, comprising:
receiving a request to control at least one of a camera and a camera enabled device to obtain camera data therefrom;
selecting and retrieving, in response to the request, at least one rule from a plurality of rules stored in one or more databases, wherein the rule determines, at least in part, whether to fulfill the request based on one or more aspects of the identity of the user and further includes at least one variable parameter representing information pertaining to a function of the user interface;
determining a value of the variable parameter;
executing the dynamic rule to select and retrieve data from the one or more databases based on the value; and
generating the user interface based on the data and from the camera data.

2-87. (canceled)
